(19) United States
(12) Patent Application Publication
(10) Pub. No.: US 2018/0232762 A1
(43) Pub. Date: Aug. 16, 2018

(54) TARGETED RESOURCE TOKEN GENERATION AND DEPLOYMENT

(71) Applicant: Bank of America Corporation, Charlotte, NC (US)

(72) Inventors: Tracy Beth Greene, Mooresville, NC (US); Emily Paige Bosin, Charlotte, NC (US); Sean Michael Gutman, Waxhaw, NC (US)

(21) Appl. No.: 15/430,017

(22) Filed: Feb. 10, 2017

(51) Int. Cl. G06Q 30/02

(52) U.S. Cl. CPC G06Q 30/0255

(57) ABSTRACT

Embodiments of the invention are directed to systems, methods and computer program products for targeted resource token generation and deployment. Embodiments receive interaction information associated with a user, wherein the interaction information comprises past interactions; in response to receiving the past interactions, determine recommended interactions based on the past interactions; determine one or more unused recommended interactions; present the unused recommended interactions to the user for consideration; generate interactive tokens based on the past interactions and the recommended interactions; prompt the user to perform one or more actions related to the unused recommended interactions; determine that the user has attained at least a threshold level of achievement; and in response, award some of the interactive tokens to the user.

### BACKGROUND

When an entity sends a targeted purchase offer to a potential customer, there is a greater likelihood that the potential customer actually takes advantage of the purchase offer. By sending purchase offers to potential customers who will likely use the purchase offers and excluding those who will likely not use the purchase offers, an entity can save millions of dollars in sending out purchase offers to those who will likely not use the purchase offers. Therefore, there is a need for a system to produce targeted purchase offers.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method, and computer program product for interaction manipulation and implementation for resource storage, the system comprising: at least one memory device with computer-readable program code stored thereon; at least one communication device connected to a network; at least one processing device operatively coupled to the at least one memory device and the at least one communication device, wherein the processing device is configured to execute the computer-readable program code to: receive interaction information associated with a user, wherein the interaction information comprises past interactions; in response to receiving the past interactions, determine recommended interactions based on the past interactions; determine one or more unused recommended interactions; present the unused recommended interactions to the user for consideration; generate interactive tokens based on the past interactions and the recommended interactions; prompt the user to perform one or more actions related to the unused recommended interactions; determine that the user has attained at least a threshold level of achievement; and, in response, award some of the interactive tokens to the user.

In some embodiments, the processing device is further configured to execute the computer-readable program code to modify future user interactions including enrolling the user in at least one recommended interaction. In some such embodiments, the processing device is further configured to execute the computer-readable program code to: generate and present a request for a confirmation the user wishes to enroll in the at least one recommended interaction; receive the confirmation of the user's desire to enroll in the at least one recommended interaction from the user; and based on receiving the confirmation, implement the enrollment.

In some embodiments, the processing device is further configured to execute the computer-readable program code to: receive a user's instruction to redeem one or more deals; and, in response, award some of the interactive tokens to the user.

In some embodiments, the processing device is further configured to execute the computer-readable program code to: present one or more programs to the user; receive the user's input regarding the one or more programs; and enable functionality corresponding to the unused recommended interactions for the user.

In some embodiments, performing the one or more actions comprises enrolling in one or more programs available to the user. In some such embodiments, the processing device is further configured to execute the computer-readable program code to determine a number of tokens awarded to the user exceeds a predetermined threshold; and, in response, determine that the user has unlocked an interactive game.

### BRIEF DESCRIPTION OF THE DRAWINGS

Having thus described embodiments of the invention in general terms, reference will now be made to the accompanying drawings, where:

FIG. 1 is a flowchart illustrating a general process flow for implementing rule-based offer association, in accordance with embodiments of the present invention;

FIG. 2 is a flowchart illustrating a general process flow for queuing input information for performing rule-based offer association, in accordance with embodiments of the present invention;

FIG. 3 is a flowchart illustrating a general process flow for implementing an intelligent offer tool, in accordance with embodiments of the present invention;

FIG. 4 is a block diagram illustrating technical components of a system for implementing the various processes described herein, in accordance with embodiments of the present invention;

FIG. 5 is a flowchart illustrating a general process flow for substituting a first offer with a second offer, in accordance with embodiments of the present invention;

FIG. 6 is a flowchart illustrating a general process flow for applying offers to purchase transactions at settlement, in accordance with embodiments of the present invention;

FIG. 7 is another flowchart illustrating a general process flow for enabling a user to determine whether a transaction qualifies for an offer, in accordance with embodiments of the present invention;

FIG. 8 is another flowchart illustrating a general process flow for responding to user transactions, in accordance with embodiments of the present invention;

FIG. 9 is another flowchart illustrating a general process flow for initiating presentation of a rebate associated with a transaction, in accordance with embodiments of the present invention;

FIG. 10 is an exemplary user interface presenting a rebate associated with a transaction, in accordance with embodiments of the present invention;

FIG. 11 is a diagram of an environment for targeted resource generation and deployment are enabled according to embodiments of the invention;

FIG. 12 is a flowchart illustrating a process for targeted resource generation and deployment according to embodiments of the invention; and

FIGS. 13A-13E are screenshots of mobile device interfaces for targeted resource generation and deployment according to embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Various embodiments of the invention are directed to targeted resource token generation and deployment. Embodiments generate gamification for awarding a customer for improving his or her financial wellness. Linking gamification to one or more rewards programs or other functionality previously unused by the customer, embodiments, reward customers by enrolling in previously unused programs. The system may identify customers to target that are not using the bank platforms desired. The system may provide the customer with opportunities to join the platform and, in return, the system generates and awards the customer with tokens (i.e., virtual coins, coupons, markers, chips or other virtual awards/rewards or real awards/rewards). Furthermore, each time a qualifying deal or banking platform is utilized a coin may be awarded to the customer. In other embodiments, trying something new or integrating into a new channel may award a coin. Thus, the system is encouraging a customer to enroll in or utilize various channels and platforms available to the customer that may be underutilized by the customer. These coins are stored and accumulated. The coins a customer collects may correspond to levels of opportunity. Each level generates a game or other interaction based on the level and may provide a cash award, charity donation, or the like upon completion of the game. The games are typically provided on a financial institution directed platform for games (i.e., on a mobile application or online banking session or widget) that actually provides a meaningful reward to the customer.

Other embodiments of the invention are directed to systems, methods and computer program products for implementing an exemplary rewards program potentially utilized in conjunction with the targeted resource token generation and deployment system. The rewards program provides rule-based offer association and queuing input information for performing rule-based offer association, and an offer tool for determining whether to present an offer to a user. Additionally, embodiments of the invention are directed to systems, methods, and computer program products for initiating presentation of a rebate associated with a transaction. The invention enables an entity to send targeted offers to a user that enables the user to receive at least one of a discount or a rebate on a purchase from a third-party merchant. As used herein, an offer may also be referred to as a coupon (e.g., an electronic coupon).

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded).

As an example, an entity (e.g., a financial institution) may send an offer to a user (e.g., an account holder). The offer may be presented to the user via at least one of the user's electronic banking account (e.g., online banking account, mobile banking account on a portable mobile communication device, or the like), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

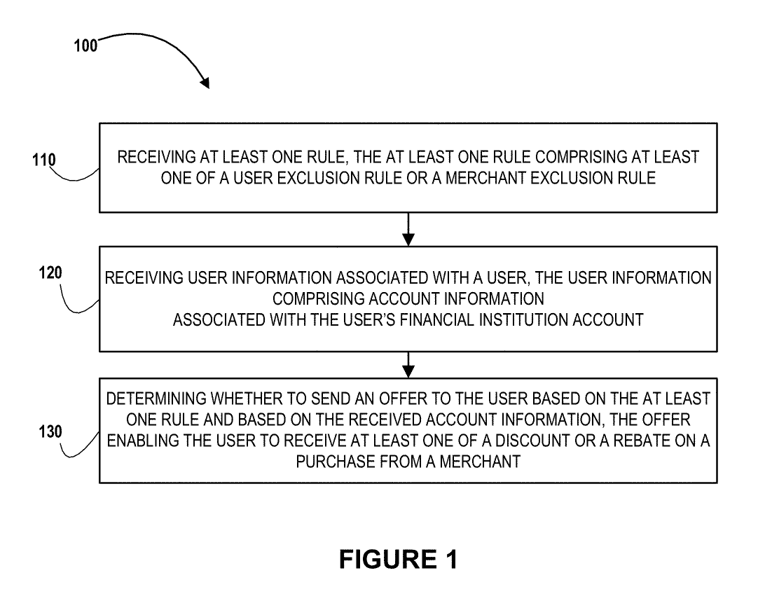

Referring now to FIG. 1, a general process flow 100 is provided for implementing rule-based offer association. At block 110, the method comprises receiving at least one rule, the at least one rule comprising at least one of a user exclusion (or user filtering) rule or a merchant exclusion (or merchant filtering) rule. At block 120, the method comprises receiving user information associated with a user, the user information comprising account information associated with the user's financial institution account. At block 130, the method comprises determining whether to send an offer to the user based on the at least one rule and based on the received user information, the offer enabling the user to receive at least one of a discount or a rebate on a purchase from a merchant. As described previously, in some embodiments, the discount or rebate is received at a point of time in the future when the transaction that qualifies for the offer is processed by the financial institution.

In some embodiments, account information, as used herein, refers to information associated with the user's financial institution account(s) managed by a single financial institution. In other embodiments, account information may refer to information associated with the user's financial institution accounts managed by multiple distinct financial institutions.

As used herein, a user exclusion rule is a rule that excludes some users from receiving offers. In some embodiments, the at least one user exclusion rule comprises an affinity exclusion rule. Therefore, if the financial institution (or a merchant partner associated with the financial institution) already has an existing relationship (e.g., for providing or sending offers associated with the particular merchant) with some users via an affinity program, those users are excluded from receiving an offer. The affinity exclusion rule comprises at least one of a full affinity exclusion rule or a partial affinity exclusion rule. When the affinity rule comprises a full affinity exclusion rule, the user is completely excluded from receiving an offer (e.g., an offer associated with a particular merchant) if the financial institution (or a merchant partner associated with the financial institution) already has an existing relationship with the user. When the affinity rule comprises a partial affinity exclusion rule, the user is excluded from receiving an offer associated with a particular product, service, or industry associated with a particular merchant that already has an existing relationship with the user for the particular product, service, or industry, but the user may receive offers associated with other products, services, or industries associated with the particular merchant. Additionally or alternatively, the user is excluded from receiving an offer associated with a competitor of a particular merchant if that particular merchant already has an existing relationship with the user.

In some embodiments, the at least one user exclusion rule comprises a risk exclusion rule. Therefore, if a user is determined to be a risky user (e.g., has a credit score lower than a predetermined threshold), the user is excluded from receiving an offer. In some embodiments, the at least one user exclusion rule comprises an account exclusion rule. Therefore, for example, if a user's account has a balance (or another account characteristic) that is lower than predetermined threshold, the user is excluded from receiving an offer.

In some embodiments, a merchant exclusion rule is a rule that excludes some merchants from providing offers to users associated with the financial institution. In some embodiment, the at least one merchant exclusion rule comprises a merchant category code exclusion rule. Therefore, a merchant associated with a predetermined merchant category code (e.g., a healthcare code) is excluded from providing an offer. However, the financial institution may set up a list of merchants that trigger exceptions. Merchants that trigger exceptions can provide offers even if these merchants are associated with the excluded merchant category codes.

In some embodiments, the account information comprises a transaction history associated with the user's financial institution account. The transaction history includes the types of transactions, frequency of transactions, amount of each transaction, merchants associated with transactions, account balance history, or the like. Additionally or alternatively, the account information may or may not comprise information associated with incorrect, inconsistent, incomplete, or corrupted transactions. As used herein, a transaction may comprise a purchase, a deposit, a withdrawal, a credit, a debit, or the like.

In some embodiments, the user information comprises other information as well. For example, in some embodiments, the user information comprises personal information (e.g., demographic information, salary information, contact information (mailing address, email address, phone number, or the like), residence address history, education information, job profile information, or the like) associated with the user. In some embodiments, the personal information further comprises social network information associated with the user's social network account or other non-account related information associated with the user. In some embodiments, the user information further comprises user information (e.g., personal information, account information, or the like) associated with the user's immediate or extended family members or contacts (e.g., as determined from social network information).

In some embodiments, when a purchase transaction is processed by the financial institution at a predetermined time in the future (i.e., at settlement time or processing time), the system determines whether the offer is still active and whether the offer is still valid with respect to both the user and the merchant. This post-transaction process may be referred to as an offer reconciliation process. The offer is still active if the offer has not been revoked by at least one of the financial institution or the merchant and/or if the offer has not expired.

The offer is valid with respect to the merchant if the merchant is not excluded under any merchant exclusion rules. As described previously, the merchant's offer may be transmitted to or presented to the user if the merchant is not excluded under any merchant exclusion rules. In some embodiments, in order for the offer to be valid, the merchant cannot be excluded under any merchant exclusion rules that were in force at the time of the purchase transaction. Additionally or alternatively, in some embodiments, in order for the offer to remain valid, the merchant cannot be excluded under any merchant exclusion rules that are in force at the time of settlement of the offer. Therefore, in some embodiments, the merchant cannot be excluded under any new merchant exclusion rules that have been introduced since the purchase transaction.

The offer is valid for the user if the user is not excluded under any user exclusion rules. As described previously, the user is presented with the merchant's offer if the user is not excluded under any user exclusion rules. In some embodiments, in order for the offer to be valid, the user cannot be excluded under any user exclusion rules that were in force at the time of the purchase transaction. Additionally or alternatively, in some embodiments, in order for the offer to remain valid, the user cannot be excluded under any user exclusion rules that are in force at the time of settlement of the offer. Therefore, in some embodiments, the user cannot be excluded under any new user exclusion rules that have been introduced since the purchase transaction.

If both the user and the merchant are not excluded at the time of settlement, the offer is still valid and the financial institution provides a rebate to the user's financial institution account. In some embodiments, if at least one of the user or the merchant is excluded at the time of settlement, the offer is invalid and the financial institution does not provide a discount or rebate to the user's financial institution account. However, in alternate embodiments, even if at least one of the user or the merchant is excluded at the time of settlement, the offer remains valid as long as the user and the merchant were not excluded at the time of the purchase transaction, and consequently the financial institution provides a discount or rebate to the user's financial institution account.

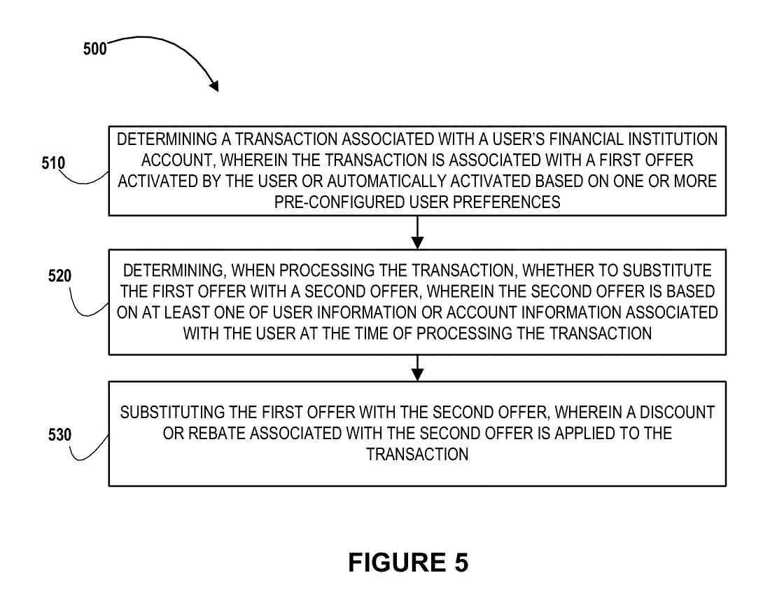

Referring now to FIG. 5, a general process flow 500 is provided for substituting a first offer with a second offer. At block 510, the method comprises determining a transaction associated with a user's financial institution account, wherein the transaction is associated with a first offer activated by the user of the financial institution account or automatically activated based on one or more pre-configured user preferences. At block 520, the method comprises determining, when processing the transaction, whether to substitute the first offer with a second offer, wherein the second offer is based on at least one of user information or account information associated with the user at the time of processing the transaction. At block 530, the method comprises substituting the first offer with the second offer, wherein a discount or rebate associated with the second offer, and not the first offer, is applied to the transaction. The process for substituting a first offer with a second offer is described herein. In some embodiments, the first offer is substituted with the second offer at the time of processing the transaction based on information associated with the user's relationship (e.g., account information or user information described herein) with the financial institution.

When the first offer is substituted with the second offer, a notification may be transmitted to the user. The notification may be transmitted via email, text message, social networking message, or the like. The notification may indicate the reasons for the substituting the first offer with the second offer, and the effect of substituting the first offer with the second offer (e.g., the user receives a bigger discount or rebate). The notification may be transmitted either prior to, at, or after the offer substitution. In some embodiments, the user may select an option on the user's mobile device to either accept or reject the offer substitution.

In some embodiments, at the time of settlement of the offer (referred to as the first offer), the system determines whether to substitute the first offer with a second offer. If the first offer is substituted with the second offer, a rebate or discount associated with the second offer, and not the first offer, is applied to the transaction or to the user's financial institution account. The time of settlement of the offer may also be referred to as the time of processing the transaction.

In some embodiments, the first offer is substituted with the second offer if the first offer, which was active when the transaction occurred, has been revoked by at least one of the financial institution or a merchant prior to the processing of the transaction. In some embodiments, the first offer is substituted with the second offer if the first offer, which was active when the transaction occurred, has expired by the time of processing of the transaction.

In some embodiments, the first offer is transmitted to or presented to the user based on at least one of user information or account information described herein. As explained herein, the account information comprises a transaction history associated with the user's financial institution account. The transaction history may comprise at least one of a type of a transaction, a frequency associated with the transaction, an amount associated with the transaction, or a merchant associated with the transaction. Additionally or alternatively, the account information comprises an account balance history. As explained herein, the user information comprises personal information associated with at least one of the user, a family member of the user, or a friend of the user, wherein the personal information comprises at least one of demographic information, salary information, contact information, residence address information (may also be referred to as mailing address information), job profile information, education information, or social network information.

Therefore, the first offer is transmitted to or presented to the user based on substantially matching the user information or account information to the first offer information. For example, the first offer is based on the residence address of the user or based on the transaction history of the user's financial institution account. The first offer may be substituted with the second offer based on a change in the user information or account information described herein. For example, the user may change the user's residence address between the occurrence of the purchase transaction and the processing of the transaction. As a further example, the user's purchase habits may change (consequently resulting in a change in the transaction history) between the occurrence of the purchase transaction and the processing of the transaction. When there is a change in the user information or account information, the first offer information no longer substantially matches at least one of the user information or account information. The first offer is therefore replaced with a second offer at the time of processing the transaction, where the second offer information substantially matches at least one of the user information or account information at the time of processing the transaction.

As explained herein, the first offer is transmitted to or presented to the user based at least partially on the user not being excluded by at least one user exclusion rule associated with the first offer and the merchant not being excluded by at least one merchant exclusion rule associated with the first offer. As explained herein, a user exclusion rule comprises at least one of an affinity exclusion rule, a risk exclusion rule, or an account exclusion rule, and a merchant exclusion rule comprises a merchant category code exclusion rule. Additionally, as explained herein, some merchants associated with an excluded merchant category code are not excluded. As explained earlier, the first offer that was valid at the time of the transaction may not be valid at the time of processing the transaction because the user or the merchant may be excluded from the first offer by at least one of a user exclusion rule or a merchant exclusion rule. The user may be excluded based on a change in account information (e.g., change in transaction history) or change in user information (e.g., change in residence address) associated with the user. The merchant may be excluded based on a change in information (e.g., change in merchant category code) associated with the merchant.

In some instances, a user exclusion rule or a merchant exclusion rule associated with the first offer may change between the occurrence of the purchase transaction and the processing of the transaction, and that change may cause the user to be excluded or the merchant to be excluded thereby resulting in the user not receiving a rebate or discount associated with the first offer. In other instances, a user exclusion rule or a merchant exclusion rule associated with the first offer may be introduced after the occurrence of the transaction, and this new user exclusion rule or merchant exclusion rule may cause the user or merchant to be excluded thereby resulting in the user not receiving a rebate or discount associated with the first offer. Therefore, in such instances where the user or the merchant is excluded, at the time of processing the transaction, by a user exclusion rule or a merchant exclusion rule associated with the first offer, the first offer may be substituted with a second offer, where neither the user nor the merchant is excluded by a user exclusion rule or a merchant exclusion rule associated with the second offer at the time of processing the transaction.

As described previously, the first offer is an offer that is transmitted to or presented to the user. The first offer is either manually activated by the user or is automatically activated based on one or more preferences established by the user. In some embodiments, the second offer is an offer that has neither been transmitted to or presented to the user, nor has been activated by the user, and nor has been activated based on one or more pre-configured user preferences. The second offer may be an offer that was introduced by the merchant after the purchase transaction has already occurred. In alternate embodiments, the second offer may be an offer that was presented to the user but was neither activated by the user nor activated based on one or more preconfigured user preferences. In other alternate embodiments, the second offer may be an offer that was presented to the user and activated by the user or activated based on one or more pre-configured user preferences.

In some embodiments, the first offer is substituted with the second offer if the second offer provides a bigger discount or rebate and the user qualifies for the second offer at the time of processing the transaction based on the user information and/or the account information associated with the user. In some embodiments, the second offer may be a discount or rebate that is applied to a different transaction from the transaction associated with the first offer, and consequently no offers may be applied to the transaction associated with the first offer. In some embodiments, the different transaction may be associated with a different merchant. Therefore, the second offer may be associated with a different merchant from the first offer. The system may apply the second offer to a different transaction because the resulting rebate is larger compared to the second offer being applied to the original transaction.

In some embodiments, the first offer may be substituted with a second offer, where the second offer provides a smaller rebate or discount compared to the first offer. The substitution may have been necessitated because a condition associated with substituting the first offer with a second offer has been satisfied (e.g., change in at least one of user information or account information between occurrence of the transaction and processing of the transaction, change in user exclusion rule or merchant exclusion rule between occurrence of the transaction and processing of the transaction, first offer has been revoked or has expired at the time of processing the transaction, or the like).

As explained herein, a user may also refer to a family or a household comprising a plurality of users (e.g., husband, wife, and kids). The account information and/or user information associated with the various users in the household may be considered cumulatively for various purposes described herein (e.g., offer substitution). The account information may comprise account information associated with a single account that is accessible to the various users in the household, or may comprise account information associated with separate accounts associated with various users in the household.

In some embodiments, the system described herein may determine that the user has activated an offer, but has not made a purchase associated with the offer for a predetermined period after activating the offer. Additionally, the system may determine, based on the user's account information (e.g., transaction history), that the user has made purchases for goods or services at a merchant that competes with the merchant associated with the activated offer. In order to encourage the user to make a purchase associated with the activated offer, the system may adjust the offer (e.g., increase the rebate or discount amount associated with the offer, replace the merchant associated with the offer with the merchant from which the user made purchases during the predetermined period, or the like). The offer adjustment may be communicated to the user to encourage the user to make a purchase associated with the adjusted offer. Additionally or alternatively, the system may, at the time of settlement of the user's purchase made during the predetermined period after activating the offer, substitute the offer with the adjusted offer (may be referred to as the second offer) so that the user receives a discount or rebate on the user's purchase. Prior to applying the adjusted offer, the system determines whether the user qualifies for the adjusted offer.

In some embodiments, the system described herein may determine that the user does not activate offers associated with a particular merchant (and/or service or good), but has made purchases from a competing merchant for similar services or goods. Based on this determination, the system may, in the future, transmit to the user offers associated with the merchant from which the user made purchases. In other embodiments, at the time of settlement of the user's purchases, the system applies an offer associated with the merchant from which the user made purchases. Prior to applying the offer, the system determines whether the user qualifies for the offer.

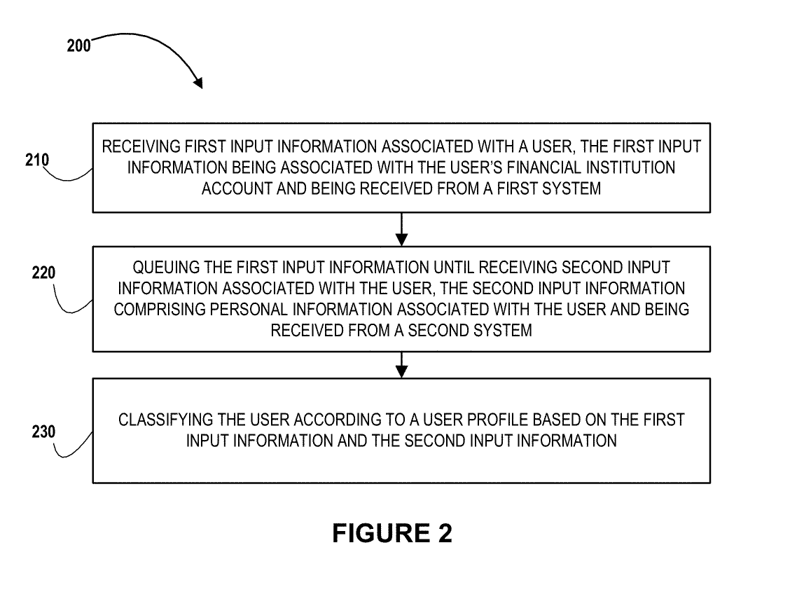

Referring now to FIG. 2, a general process flow 200 is provided for queuing input information for performing rule-based offer association. The input information may include various types of information associated with a user. For example, the input information may include account information associated with the user's financial institution account and personal information associated with the user or the user's financial institution account. In some embodiments, the input information may include information received from external systems (e.g., systems not managed by the financial institution that manages the user's financial institution account). For example, the input information may include social network information associated with the user's social network account. Therefore, each type of input information is queued on a single queue (or multiple queues) until enough input information is received to classify the user based on one or more predetermined user profiles as described below. The invention is not limited to any duration of time that the input information spends on a queue.

At block 210, the method comprises receiving first input information associated with a user, the first input information being associated with the user's financial institution account and being received from a first system. At block 220, the method comprises queuing the first input information until receiving second input information associated with the user, the second input information comprising personal information associated with the user and being received from a second system. At block 230, the method comprises classifying the user according to a user profile based on the first input information and the second input information.

The first system is separate from the second system. In some embodiments, the first system and the second system may be managed by different entities. For example, the first system is managed by a financial institution that manages the user's financial institution account, and the second system is managed by an external entity that provides personal information regarding the user to the financial institution.

In alternate embodiments, the second input information, in addition to or instead of comprising personal information associated with the user and being received from a second system, comprises information associated with the user's financial institution account and is received from a third system that is managed by the financial institution. The third system is distinct from both the first and second systems, and the account information received from the third system is different from the account information received from the first system. For example, the account information received from the first system comprises the transaction history for a predetermined period of time (e.g., the previous three months), and the account information received from the third system comprises information regarding bill payment history associated with bills being paid from funds associated with the user's financial institution account. Alternatively, the account information received from the third system comprises information regarding mortgage payments associated with a mortgage loan provided by one of the financial institution that manages the user's financial institution account or a different financial institution. Alternatively, the account information received from the third system comprises the user's status. In some embodiments, the status may indicate whether the user is eligible to receive offers associated with particular purchases (either a past purchase or a future purchase) or particular merchants. In some embodiments, the status may indicate the standing of the user's financial institution account.

In other alternate embodiments, the first input information comprises personal information associated with the user that is received from the second system. This first input information is queued until second input information associated with the user's financial institution account is received from the first system.

In some embodiments, the first input information comprises information associated with single-holder accounts (no joint holders) associated with the user, and the second input information comprises information associated with joint accounts associated with the user.

In some embodiments, the process flow 200 further comprises receiving at least one rule; the at least one rule comprising at least one of a user exclusion rule or a merchant exclusion rule. In some embodiments, the process flow 200 further comprises determining whether to send an offer to the user based on the at least one rule and based on the received first input information and second input information, the offer enabling the user to receive at least one of a discount or a rebate on a purchase from a merchant.

In some embodiments, the first input information comprises a transaction history associated with the user's financial institution account. In some embodiments as described herein, the transaction history may be associated with a predetermined time period (e.g., the previous three months). The transaction history includes the types of transactions, frequency of transactions, amount of each transaction, merchants associated with transactions, account balance history, or the like. Additionally or alternatively, the account information may or may not comprise information associated with incorrect, inconsistent, incomplete, or corrupted transactions. As used herein, a transaction may comprise a purchase, a deposit, a withdrawal, a credit, a debit, or the like.

In some embodiments, the second input information (e.g., personal information) comprises demographic information, salary information, contact information (mailing address, email address, phone number, or the like), residence address history, social network information, education information, job profile information, or the like. In some embodiments, the second input information may also comprise personal information or account information associated with the user's immediate or extended family members or contacts (e.g., as determined from social network information).

In some embodiments, the user profile comprises a collection of users that are associated with similar characteristics. These characteristics may relate to the users' account transactional behavior (e.g., types of transactions, frequency of transactions, amount of each transaction, merchants associated with transactions, account balance history, or the like). As used herein, a transaction may comprise a purchase, a deposit, a withdrawal, a credit, a debit, or the like. Additionally or alternatively, these characteristics may relate to the users' personal characteristics (e.g., demographic information, salary information, location information, social network information, education information, job profile information, or the like).

In some embodiments, the first input information comprises account information or personal information associated with the user, and the second input information comprises account information or personal information associated with the user. Additionally, the financial institution may establish one or more criteria (e.g., the exclusion rules described herein) to determine whether the user qualifies to receive an offer associated with a merchant. Therefore, as an example, a user qualifies for an offer (or an offer is sent to a user) if two pieces of information (e.g., the user's transaction history and the user's mailing address) are received. The transaction history is received as part of the first input information and waits on a first queue. At a later point in time, the mailing address is received as part of the second input information. When the mailing address is received, the system determines that the criteria has been satisfied, and the first input information is combined with the second input information to determine that the user qualifies for the offer (or to determine that the offer can be transmitted to the user).

In some embodiments, the queue comprising the first input information is reorganized into a cached area of the system. Additionally or alternatively, the queue comprising the second input information is reorganized into a cached area of the system. This reorganization process improves the processing speed of any process that uses at least one of the first input information or the second input information.

In some embodiments, the system associated with the financial institution receives account information or personal information from a source either external to or internal to the financial instruction. For example, the system receives transaction history associated with a user from a merchant. The system described herein is enabled to receive information (e.g., a string of information) from an external source and identify and exclude some personal information (e.g., social security number, credit card number, or the like) associated with the user, where the excluded personal information is not considered in processing the input information associated with the user (e.g., determining whether the user qualifies to receive an offer). Therefore, for example, the system is enabled to determine a nine digit number (could be a social security number) in the string of information received from the merchant and exclude the nine digit number. As a further example, the system is enabled to determine a sixteen digit number (could be a credit or debit card number) in the string of information received from the merchant and exclude the sixteen digit number.

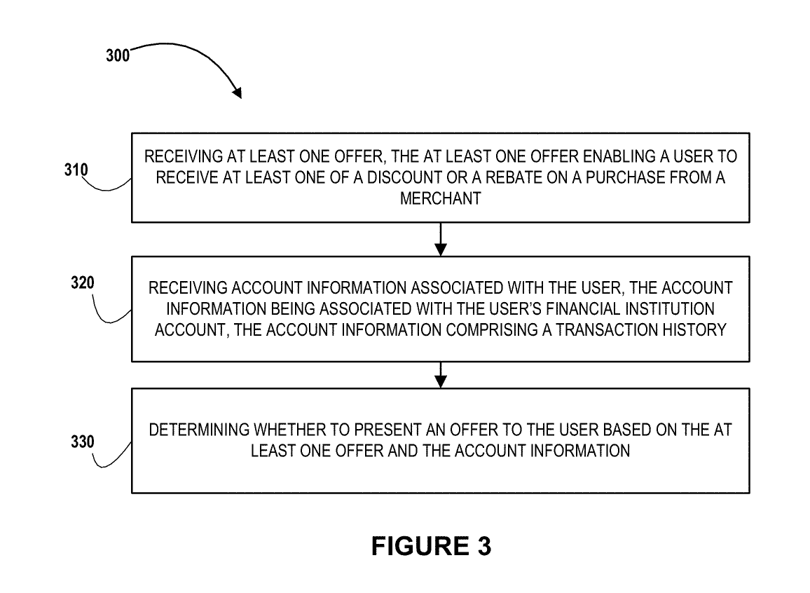

Referring now to FIG. 3, a general process flow 300 is provided for implementing an intelligent offer tool. At block 310, the method comprises receiving at least one offer, the at least one offer enabling a user to receive at least one of a discount or a rebate on a purchase from a merchant. At block 320, the method comprises receiving account information associated with the user, the account information being associated with the user's financial institution account, the account information comprising a transaction history. At block 330, the method comprises determining whether to present an offer to the user based on the at least one offer and the account information. Therefore, the determining step comprises matching an offer to an account (e.g., based on the account information) such that there is a high likelihood (e.g., greater than a threshold probability) that the user associated with the account uses the offer to make a purchase using a payment method associated with the account.

In some embodiments, at block 320, the method further comprises receiving user information associated with the user. The user information includes both account information and personal information associated with the user as described previously with respect to FIGS. 1 and 2. In such embodiments, at block 330, the method comprises determining whether to present an offer to the user based on the at least one offer and the user information.

In some embodiments, the process flow 300 further comprises determining, from the transaction history, whether to exclude a transaction, the excluded transaction being associated with at least one of incorrect, inconsistent, incomplete, or corrupted merchant information or incorrect, inconsistent, incomplete, or corrupted transaction information. Therefore, if a merchant no longer exists, transactions associated with that merchant are excluded. Additionally, if there were inconsistencies in the transaction or merchant information between when the transaction was executed (i.e., when the purchase was made) and when the transaction was processed by the financial institution, such a transaction is excluded as well. Additionally, in some embodiments, an excluded transaction may be a transaction disputed by at least one of the user or the merchant. Excluded transactions are excluded from the process of determining whether to present an offer to a user.

In some embodiments, the system does not exclude a transaction. Instead, the system intelligently determines whether transactions have been incorrectly keyed-in or whether transactions comprise incorrect merchant information. For example, the system intelligently determines that a merchant's name has changed (e.g., from Merchant ‘A’ to Merchant ‘B’), and considers transactions associated with both Merchant ‘A’ and Merchant ‘B’ as being associated with the same merchant. As a further example, the system may determine that a transaction is only partially complete (e.g., missing merchant information or price information, or the like). In such an instance, the system may determine that available information associated with the partially complete transaction is similar to one or more other transactions in the transaction history. In such an instance, the system may add information to the partially complete transaction based on the one or more similar transactions or based on other information provided to the system. As a further example, the system may determine that a transaction may have incorrect information (e.g., a price that is too high or too low, a merchant's name spelled incorrectly, or the like). In such an instance, the system may determine that information associated with the inconsistent or incorrect transaction is similar to one or more other transactions in the transaction history. In such an instance, the system may rectify the inconsistent or incorrect transaction based on the one or more similar transactions or based on other information provided to the system.

In some embodiments, the presented offer is associated with a selected payment method. Exemplary payment methods include paying via a credit card, debit card, personal check, mobile device, or the like. The exemplary payment methods are not limited to those described herein. In some embodiments, the payment method is selected by at least one of the financial institution, the merchant, or the user.

In some embodiments, the offer is presented via at least one of a user interface associated with the user's financial institution account (e.g., online banking account, mobile banking account on a portable mobile communication device, or the like) or a user interface associated with the user's social network account. In some embodiments, the offer is inserted into or presented alongside (e.g., on the right, left, top, bottom side of a transaction, or between multiple transactions) the transaction history that is presented on the user's online banking account or mobile banking account. Therefore, for example, if ten transactions are listed in the transaction history, the offer may be presented between the fourth and fifth transactions. In some embodiments, the offer may be related to the transaction which the offer is presented alongside (e.g., the fourth and/or fifth transaction in the above example). For example, if the fourth transaction is a purchase of item ‘A’ from merchant ‘A,’ the offer is for a purchase of item ‘A’ (e.g., from any merchant) or for a purchase from merchant ‘A’ (e.g., for any item) or for a purchase of item ‘A’ from merchant ‘A.’ Alternatively, the offer may be for a purchase of a substitute of item ‘A’ (e.g., from merchant ‘A’ or from any other merchant). In some embodiments, the offer is transmitted to the user's email account. In other embodiments, the offer is transmitted, via text message, to the user's mobile device.

In some embodiments, the presented offer is an offer to receive at least one of a discount or a rebate on at least one of a purchase previously made by the user (e.g., a previous transaction associated with the user's financial institution account), a purchase from a merchant from which the user previously made a purchase, an alternative to the purchase previously made by the user, or an alternative to the purchase from the merchant from which the user previously made a purchase. The alternative to the purchase may be determined based on transaction histories associated with a plurality of financial institution accounts associated with multiple users.

In some embodiments, the presented offer is an offer to receive at least one of a discount or a rebate on a product or service related to a previous purchase made by the user. For example, if the user previously bought a stove, the offer is a discount or rebate for a dishwasher or a stove maintenance service.

In some embodiments, an offer that is sent to or presented on a financial institution account associated with a first member of a family may be used (or redeemed) by a second member of the family. In some embodiments, the second member of the family may use the offer even if the second member is not associated with the financial institution account associated with the first member. For example, the offer associated with a particular merchant may be transmitted to (or linked to) a credit card account associated with a first family member. When the second member of the family makes a purchase that qualifies for the offer using the second member's credit card (or any other qualifying payment method), the second member receives the rebate after making the purchase. The financial institution may have access to information that indicates that the second member is a family member of the first member even if the second member is not listed as being associated with the financial institution account associated with the first member.

Additionally, in some embodiments, as part of the previously described offer reconciliation process at the time of settlement of the offer, the system determines whether the account information substantially matches the offer information. If the account information has changed since the purchase transaction such that the account information no longer substantially matches the offer information, the offer may be deemed to be invalid and the financial institution does not provide a rebate to the user's financial institution account. However, in other embodiments, even if the account information has changed since the purchase transaction, the offer remains valid and the financial institution provides a rebate to the user's financial institution account.

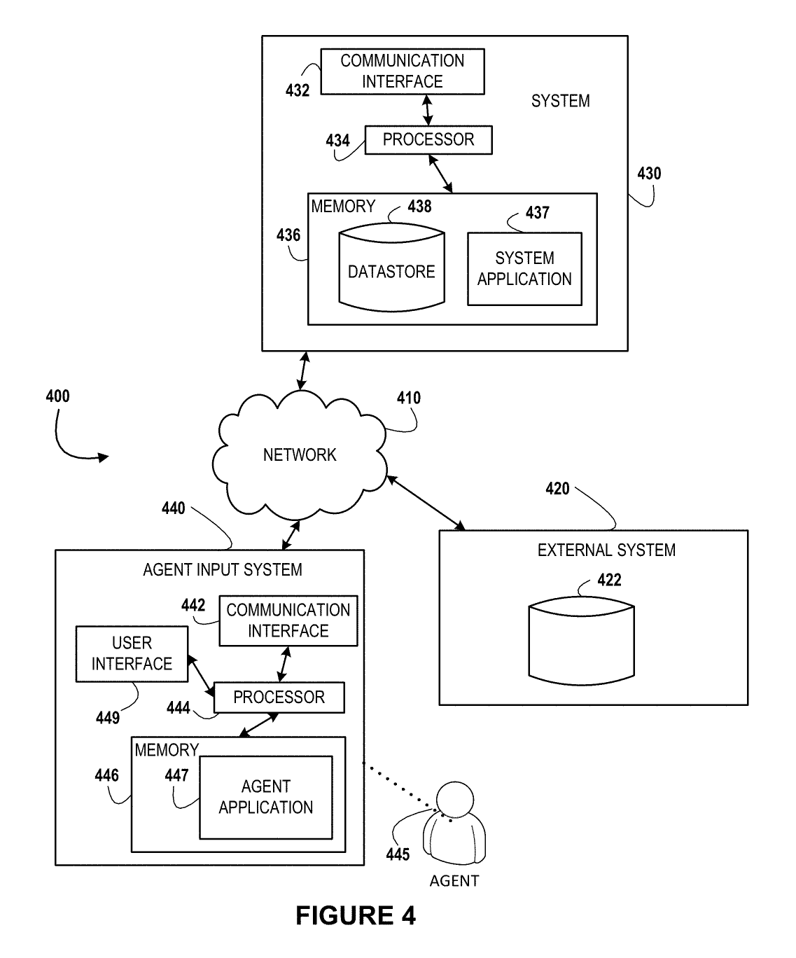

Referring now to FIG. 4, FIG. 4 presents an exemplary block diagram of the system environment 400 for implementing any of the process flows described herein, in accordance with embodiments of the present invention. As illustrated, the system environment 400 includes a network 410, an external system 420, a system 430, and an agent input system 440. Also shown in FIG. 4 is an agent 445 of the agent input system 440. The agent 445 may be a person who uses the agent input system 440 to execute an agent application 447 or uses the agent input system 440 to initiate execution of a system application 437. The agent application 447 and/or the system application 437 may incorporate one or more parts of the process flows described herein. The agent may be an employee of the entity that manages the system 430 and/or the external system 420. In other embodiments, the agent may not be an employee of an entity, but may still provide a service under the direction and/or supervision of the entity. Alternatively, the agent input system 440 may be a user input system associated with a user of a financial institution account as described herein. The features associated with the agent input system 440 are also applicable to the user input system. As described herein, a user input system may be a portable mobile device such as a portable mobile telecommunication device or a portable tablet computer.

As shown in FIG. 4, the external system 420, the system 430, and the agent input system 440 are each operatively and selectively connected to the network 410, which may include one or more separate networks. In addition, the network 410 may include a local area network (LAN), a wide area network (WAN), and/or a global area network (GAN), such as the Internet. The network may also include a mobile telecommunication network. It will also be understood that the network 410 may be secure and/or unsecure and may also include wireless and/or wireline and/or optical interconnection technology.

The external system 420 may be any computing or non-computing system that transmits information to the system 430. Additionally or alternatively, information from the system 430 may be transmitted to the external system 420. As presented in FIG. 4, the external system 420 comprises at least one datastore 422. The datastore 422 may comprise information relating to at least one of the user, the user's financial institution account, offers, rules related to targeting offers to users, personal information, or the like. As used herein, the terms “data” and “information” may be used interchangeably.

The agent input system 440 may include any computerized apparatus that can be configured to perform any one or more of the functions of the agent input system 440 described and/or contemplated herein. For example, the agent 445 may use the agent input system 440 to transmit and/or receive information or commands to and from the system 430. In some embodiments, for example, the agent input system 440 may include a personal computer system, a mobile computing device, a mobile phone, a personal digital assistant, a network device, a mobile phone, and/or the like. As illustrated in FIG. 4, in accordance with some embodiments of the present invention, the agent input system 440 includes a communication interface 442, a processor 444, a memory 446 having an agent application 447 stored therein, and an agent interface 449. In such embodiments, the communication interface 442 is operatively and selectively connected to the processor 444, which is operatively and selectively connected to the agent interface 449 and the memory 446. In some embodiments, the agent 445 may use the agent application 447 to execute processes described with respect to the process flows described herein, or may initiate the system 430 to execute the process flows described herein.

Each communication interface described herein, including the communication interface 442, generally includes hardware, and, in some instances, software, that enables the agent input system 440, to transport, send, receive, and/or otherwise communicate information to and/or from the communication interface of one or more other systems on the network 410. For example, the communication interface 442 of the agent input system 440 may include a modem, transceiver, server, electrical connection, and/or other electronic device that operatively connects the agent input system 440 to another system such as the system 430. A transceiver may include radio circuitry for wirelessly transmitting and receive information.

Each processor described herein, including the processor 444, generally includes circuitry for implementing the audio, visual, and/or logic functions of the agent input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the agent application 447 of the memory 446 of the agent input system 440.

Each memory device described herein, including the memory 446 for storing the agent application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the agent application 447. In some embodiments, the agent application 447 includes an interface for communicating with, navigating, controlling, configuring, and/or using at least one of the system 430 or the agent input system 440. In some embodiments, the agent application 447 includes computer-executable program code portions for instructing the processor 444 to perform one or more of the functions of the agent application 447 described and/or contemplated herein. In some embodiments, the agent application 447 may include and/or use one or more network and/or system communication protocols.

Also shown in FIG. 4 is the user interface 449. In some embodiments, the user interface 449 includes one or more output devices, such as a display and/or speaker, for presenting information to the agent 445. In some embodiments, the user interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 445. In some embodiments, the user interface 449 includes the input and display devices of a personal computer, such as a keyboard and monitor, which are operable to receive and display information.

FIG. 4 also illustrates a system 430, in accordance with an embodiment of the present invention. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. In some embodiments, such as the one illustrated in FIG. 4, the system 430 includes a communication interface 432, a processor 434, and a memory 436, which includes a system application 437 and a datastore 438 stored therein. As shown, the communication interface 432 is operatively and selectively connected to the processor 434, which is operatively and selectively connected to the memory 436.

It will be understood that the system application 437 may be configured to implement any one or more portions of the various user interfaces and/or process flow described herein. It will also be understood that, in some embodiments, the memory includes other applications. It will also be understood that, in some embodiments, the system application 437 is configured to communicate with the datastore 438, the agent input system 440 and/or the external system 420.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the datastore 438. As used herein, the datastore 438 may be one or more distinct and/or remote datastores. In some embodiments, the datastore 438 is not located within the system and is instead located remotely from the system. In some embodiments, the datastore 438 stores information or data described herein. For example, the datastore 438 may store information relating to at least one of the user, the user's financial institution account, offers, rules related to targeting offers to users, personal information, or the like.

It will be understood that the datastore 438 may include any one or more storage devices, including, but not limited to, datastores, databases, and/or any of the other storage devices typically associated with a computer system. It will also be understood that the datastore 438 may store information in any known way, such as, for example, by using one or more computer codes and/or languages, alphanumeric character strings, data sets, figures, tables, charts, links, documents, and/or the like. Further, in some embodiments, the datastore 438 may include information associated with one or more applications, such as, for example, the system application 437. It will also be understood that, in some embodiments, the datastore 438 provides a substantially real-time representation of the information stored therein, so that, for example, when the processor 434 accesses the datastore 438, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. For example, the system 430 and the external system 420 may be maintained by separate parties.

It will also be understood that the system 430 may include and/or implement any embodiment of the present invention described and/or contemplated herein. For example, in some embodiments, the system 430 is configured to implement any one or more of the embodiments of the process flows described and/or contemplated herein.

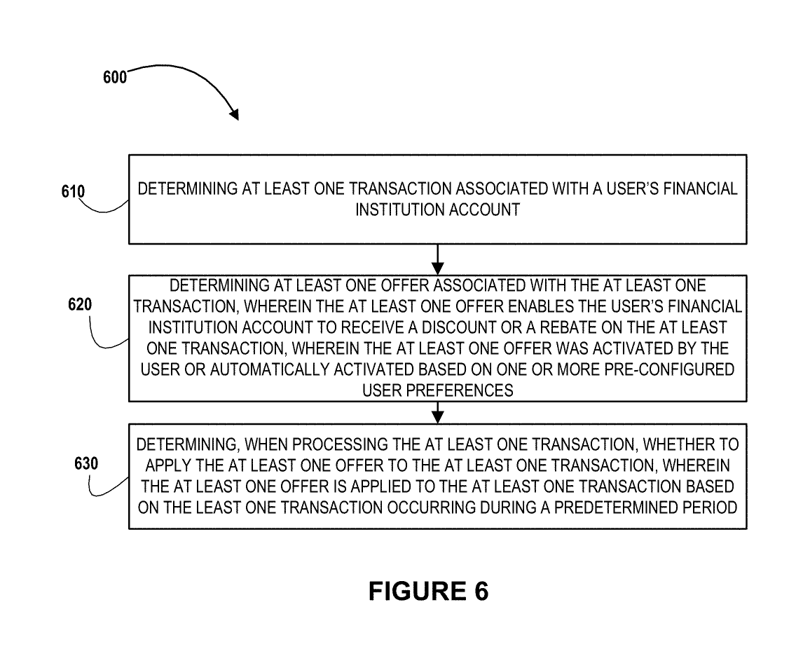

Referring now to FIG. 6, a general process flow 600 is provided for applying an offer to a transaction when processing the transaction, i.e., at settlement time. At block 610, the method comprises determining at least one transaction associated with a user's financial institution account. At block 620, the method comprises determining at least one offer associated with the at least one transaction, wherein the at least one offer enables the user's financial institution account to receive a discount or a rebate on the at least one transaction, wherein the at least one offer was activated by the user or automatically activated based on one or more pre-configured user preferences. At block 630, the method comprises determining, when processing the at least one transaction, whether to apply the at least one offer to the at least one transaction, wherein the at least one offer is applied to the at least one transaction based on the least one transaction occurring during a predetermined period. Processing a transaction and/or an offer may also be referred to as settling a transaction and/or an offer. As explained herein, in some embodiments, either an offer or a substitute of the offer (when a substitution condition is satisfied) may be applied to the transaction at settlement.

An offer may specify that the user will receive the discount or rebate on a purchase transaction if the user executes a purchase transaction between 4 PM and 6 PM on a particular day. The time frame during which the transaction needs to be executed by the user may be defined by the merchant or the financial institution. Therefore, at settlement of the offer, which may occur a predetermined period after occurrence of the transaction, the system described herein determines whether the user executed a purchase transaction between 4 PM and 6 PM on the particular day. The system described herein can determine a time (hour, minute, second) and date associated with a transaction.

In some embodiments, the offer may specify that the user will receive a 5% discount if the user executes a purchase transaction between LOAM and 6 PM on a particular day, and the user will receive an additional 5% discount if the user executes a purchase transaction between 4 PM and 6 PM on the particular day. Therefore, if the user executes a transaction between 4 PM and 6 PM on the particular day, multiple offers are applied to the transaction at settlement. Thus, at settlement, a plurality of offers may be applied to a single transaction.

In some embodiments, the offer may specify that the user will receive a 5% discount if the user is one of the first five hundred users who execute a purchase transaction between 4 PM and 6 PM on the particular day. At settlement, the system described herein receives transaction information associated with all users who executed a purchase transaction between 4 PM and 6 PM on the particular day, and determines whether the user is among the first five hundred users. If the user is not among the first five hundred users, the user does not receive a rebate or discount, and the system described herein may transmit a message to the user indicating that the user did not receive a rebate or discount because the user was not among the first five hundred users.

In some embodiments, at settlement, the at least one offer is applied to the at least one transaction based on an amount associated with the at least one transaction being greater than a predetermined amount. For example, the offer may specify that the user will receive a discount or rebate on a purchase transaction if the user executes a purchase transaction greater than a predetermined amount (e.g., $10). As a further example, the offer may specify that the user will receive a first discount or rebate (e.g., 5% off) if the user executes a purchase transaction greater than a first predetermined amount (e.g., $10), and the user will receive another discount or rebate (e.g., an additional 5% off) if the user executes a purchase transaction greater than a second predetermined amount (e.g., $25). In some embodiments, the additional discount or rebate is applied only to the difference between the first and second predetermined amounts (e.g., $15), while in other embodiments, the additional discount or rebate is applied to the entire purchase amount (e.g., $25). In some embodiments, the predetermined amount may vary from a first user to a second user, wherein the first user and the second user are associated with the same financial institution account or are associated with different financial institution accounts.

In some embodiments, the at least one transaction comprises a plurality of transactions, and the at least one offer is applied to an aggregate of the plurality of transactions. For example, the offer may specify that the user will receive the discount or rebate on all purchase transactions executed by the user between 4 PM and 6 PM on a particular day. Therefore, at settlement, the system described herein determines all transactions executed by the user between 4 PM and 6 PM on the particular day, and aggregates or adds up the transactions. Then the system applies the at least one offer to the aggregated amount. In some embodiments, some of the transactions executed by the user between 4 PM to 6 PM may be excluded (e.g., transactions that do not meet the minimum amount, transactions executed with a payment method that does not qualify for the offer, transactions executed by a user in the household who does not qualify for the offer, or the like).

In some embodiments, the at least one transaction comprises a transaction associated with the highest transaction amount. For example, the offer may specify that the user will receive the discount or rebate on the transaction associated with the highest amount executed between 4 PM and 6 PM on a particular day. Therefore, at settlement, the system described herein determines transactions executed between 4 PM and 6 PM on a particular day, and selects the transaction associated with the highest amount. Additionally, the system determines whether the selected transaction is excluded based on any exclusion rules described herein. If the selected transaction is not excluded, the at least one offer is applied to the selected transaction. If the selected transaction is excluded, the system determines the transaction associated with the next highest amount, and the at least one offer is applied to the selected transaction.

In some embodiments, the offer is applied to the first (or second, or third, or the like) transaction greater than a predetermined amount (and/or less than a second predetermined amount) after the user activated the offer. In other embodiments, the offer is applied to the largest transaction on the first day (or other predetermined period such as a particular second, minute, hour, day, week, month, or the like) when the user makes a transaction after activating the offer. Therefore, for example, the user activates an offer on Monday. On Wednesday morning, the user executes a $10 transaction that qualifies for the offer. On Wednesday evening, the user executes a $20 transaction that qualifies for the offer. In this example, the offer is applied to the $20 transaction, and not to the $10 transaction. In some embodiments, the date of a transaction is the date when a user executes the transaction. In other embodiments, the date of a transaction is the date when the merchant settles or processes the transaction.

In some embodiments, the offer is applied to a partial portion of a purchase transaction. Therefore, some goods and/or services that are part of the purchase transaction qualify for the offer, while other goods and/or services that are part of the purchase transaction do not qualify for the offer and are consequently excluded. For example, the offer may specify that the offer excludes certain types of goods (e.g., electronics, goods over $500, or the like). Therefore, the offer may be applied to an aggregate of the goods and/or services that qualify for the offer, and may not be applied to an aggregate of the goods and/or services that do not qualify for the offer.

In some embodiments, the user comprises a plurality of users, e.g., a first user and a second user. The plurality of users may comprise a family or a household (e.g., husband, wife, and kids). Therefore, the offer may specify that the user will receive a discount or rebate on transactions executed between 4 PM and 6 PM on a particular day. At settlement, the system described herein determines transactions associated with the first user executed between 4 PM and 6 PM on the particular day and determines transactions associated with the second user executed between 4 PM and 6 PM on the particular day. Therefore, at settlement, the system may aggregate the first user's transactions and the second user's transactions, and apply the at least one offer to the aggregate. The transactions executed by the first user and the second user may be associated with a single financial institution account. The first user and the second user may have executed their transactions using the same or different payment methods (e.g., debit card, credit card, electronic funds transfer, mobile device payment, physical check, or the like). In some embodiments, some of the users associated with the financial institution account may be excluded from the offer. For example, the user's child is excluded from making a purchase transaction associated with certain offers. Therefore, any purchase transactions associated with excluded users are not considered when determining the rebate or discount amount to be applied to the user's financial institution account.

In some embodiments, the at least one transaction comprises a first transaction associated with a first merchant and a second transaction associated with a second merchant. Therefore, at settlement, the offer is applied to a first transaction associated with a first merchant that was executed during a predetermined period (e.g., 4 PM to 6 PM on a particular day) as specified by the offer, and is also applied to a second transaction associated with a second merchant that was executed during the same predetermined period specified by the offer.

In some embodiments, at settlement, the system determines a payment method (e.g., credit card, debit card, electronic funds transfer, mobile device payment, physical check, or the like) associated with the transaction. If the payment method qualifies as an accepted payment method as defined by offer information associated with the offer (defined by at least one of the merchant or the financial institution), the rebate or discount associated with the offer is applied to the user's financial institution account.

When the rebate or discount is applied to the user's financial institution account, the system described herein may transmit a message to the user (e.g., text message, email, social networking message, or the like) indicating the amount of rebate or discount applied to the user's financial institution account. The message may indicate how the rebate or discount amount is calculated (e.g., which transactions were considered, which transactions were excluded, or the like). When a rebate or discount associated with an activated offer is not applied to the user's financial institution account, the system may transmit a message to the user indicating the reasons why the rebate or discount is not applied to the user's financial institution account (e.g., a user associated with the transaction may be excluded, a payment method associated with the transaction may be excluded, an amount associated with the transaction may be smaller than the minimum amount required to qualify for the offer, or the like).

In some embodiments, the offer may specify that the user will receive a discount or rebate associated with the offer based on the user completing an activity and/or based on the user transmitting the offer to another user. For example, the offer may specify that the user has to complete an activity associated with the merchant associated with the offer, wherein the activity is independent of (or part of) the transaction. For example, if the offer is a 15% off offer on a minimum dine-in purchase of $50 at a restaurant, the activity may include purchasing merchandise (e.g., a T-shirt) at the restaurant. Alternatively the activity may include posting a message about the restaurant on a social network at a certain time. The activity may be independent of the user's dine-in purchase at the restaurant. Still additionally, the offer may specify that the user has to transmit the offer to a predetermined number of other users (e.g., ten other users), and may additionally specify that a predetermined percentage (e.g., 50%) of the users to whom the offer was transmitted need to execute a transaction associated with the offer either a predetermined period before or predetermined period after the user executes the transaction associated with the offer (or within a predetermined period after receiving the offer from the user). Therefore, a user successfully executes a transaction associated with the offer if the user completes the activity specified by the offer and/or transmits the offer to the predetermined number of other users. At settlement of the offer, the system may determine whether the predetermined percentage of users who received the offer from the user executed a transaction associated with the received offer within a predetermined period after receiving the offer from the user (or within a predetermined period either before or after the user's transaction associated with the offer).

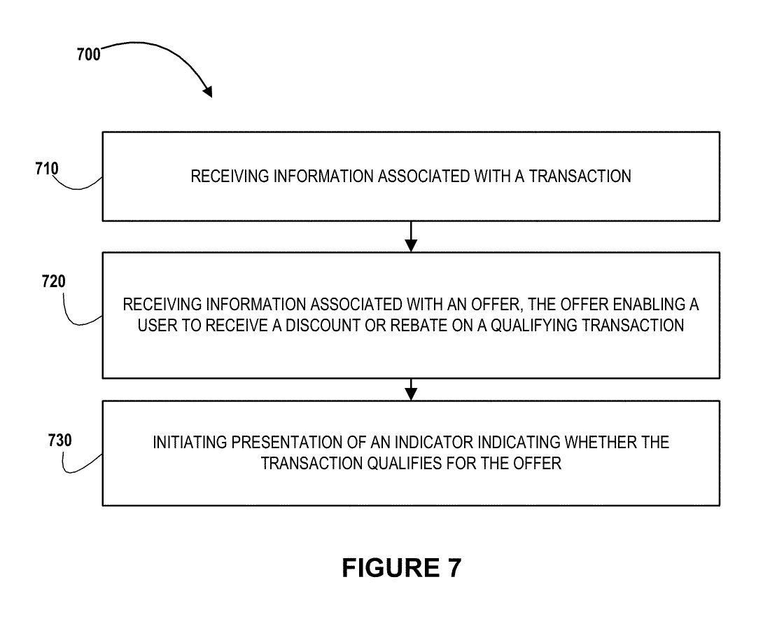

Referring now to FIG. 7, a general process flow 700 is provided for enabling a user to determine whether a transaction qualifies for an offer. At block 710, the method comprises receiving information associated with a transaction. At block 720, the method comprises receiving information associated with an offer, the offer enabling a user to receive a discount or rebate on a qualifying transaction. At block 730, the method comprises initiating presentation of an indicator (e.g., on a user's mobile device) indicating whether the transaction qualifies for the offer. The indicator may comprise a visual indicator (e.g., at least one of text, graphics, or the like). In some embodiments, the indicator may comprise a non-visual indicator (e.g., an audio beep indicating the transaction qualifies for an offer). Therefore, the present invention enables a user to view feedback associated with the user's transaction immediately after the user's transaction (in real-time or near real-time) on the user's mobile device. As described herein, the offer was activated by the user or automatically activated based on one or more pre-configured user preferences prior to occurrence of the transaction.

In some embodiments, immediately after occurrence of the transaction (e.g., after the system described herein receives information associated with the transaction), the user receives a text message, email message, social network message, financial institution network message, or the like, indicating the transaction qualifies for an activated offer (and/or indicating the amount of discount or rebate associated with the offer). Alternatively or additionally, the indicator (and/or an amount of discount or rebate associated with the offer) may be presented (e.g., immediately after the transaction occurs) adjacent to a transaction on the user's transaction history which may be accessible via at least one of the user's financial institution account or social networking account. In some embodiments, the indicator (and/or an amount of discount or rebate associated with the offer) may be presented in a pop-up window when the user selects (e.g., clicks, hovers over, or the like) a transaction from the transaction history. In some embodiments, a transaction that qualifies for an activated offer may be presented differently (e.g., different color, background, font, projection or the like) from a transaction that does not qualify for an activated offer. In some embodiments, an indicator, as described herein, may comprise an amount of discount or rebate associated with the offer. Therefore, the present invention enables a user to receive near real-time feedback on a transaction regarding whether the transaction qualifies for an offer. As used herein, the term “immediately after” may refer to an event occurring in real-time or near real-time.

In some embodiments, the system is further configured to initiate presentation of a message (e.g., on the transaction history page of an account) indicating the amount of the discount or rebate associated with the transaction may change. The change in the discount or rebate amount may be due to activity associated with at least one of the user (addition of tip, return of purchase, or the like) or the merchant (change in price of purchase or the like).

In some embodiments, information associated with the transaction comprises authorization information associated with the transaction. When a user uses a payment method (e.g., a payment card, mobile device payment, or the like) to pay a bill at a restaurant, the payment method is authorized by the user (e.g., when the payment card is swiped at a terminal or when a mobile device (or payment card) receives or transmits information (e.g., from or to a payment terminal) associated with making a payment at a merchant's establishment). There is a time delay (e.g., a few minutes, hours, days, or the like) between the authorization of the payment and the clearance of the payment. The amount associated with authorization of the payment may be different from the amount associated with clearance of the payment. For example, when a user makes a payment using the user's payment card (or mobile device) at a merchant's establishment, the user's payment card (or mobile device) is used at a payment terminal to generate a receipt. Therefore, the user's payment of $50 (amount of the bill) is authorized. The user may subsequently add a tip (e.g., $10) on the receipt. Therefore, the amount associated with clearance of the transaction will be $60, which is different from the amount associated with authorization of the transaction. Therefore, the system may transmit a message to the user immediately after the transaction occurs indicating the amount of the discount or rebate. This amount of discount or rebate is based on authorization information associated with the transaction. The message may indicate the amount of the rebate or discount may be subject to change. The change in the discount or rebate amount may be due to activity associated with at least one of the user or the merchant. In the above example, the amount of the rebate or discount changes after receiving information associated with the clearance of the payment.

As another example, a user may make a purchase at a merchant's establishment (e.g., a sports store). The user authorizes a payment at a payment terminal associated with the merchant's establishment. Immediately after the purchase, the invention may enable a user to determine whether the purchase qualifies for an offer (e.g., a previously activated offer) and/or to view a potential rebate or discount to be applied to the user's account in the future. A short time after making the purchase (and prior to clearance of the purchase transaction), the user may return to the merchant's establishment and return the purchase. Since the user returns the purchase, the payment does not get cleared. Therefore, after (e.g., immediately after) the merchant clears the transaction, the system may inform the user (e.g., via text message, email message, social network message, financial institution network message, or the like) that the purchase no longer qualifies for the offer because the user returned the purchase, and consequently, the user will not receive a rebate or discount for the purchase.

Additionally or alternatively, in some embodiments, information associated with the transaction comprises clearance information associated with the transaction. In some embodiments, the system processes the clearance information to determine (and/or confirm) whether transaction qualifies for the activated offer (and/or the an amount of discount or rebate associated with the offer). In some embodiments, when the transaction is cleared (or simultaneously with the clearing of the transaction), the rebate or discount associated with an activated offer is applied to the account (e.g., simultaneously with the clearing of the transaction). In other embodiments, the rebate or discount associated with an activated offer is applied to the account a predetermined period after the clearance of the transaction. Therefore, the batch processing operation that comprises applying a discount or rebate to a financial institution account may be executed either simultaneously with or a predetermined period after clearance of the transaction.

If the system determines, based on the clearance information, that the transaction qualifies for the activated offer, the user receives a text message, email message, social network message, financial institution network message, or the like, confirming the transaction qualifies for an activated offer (and/or indicating the amount of discount or rebate associated with the offer). Alternatively or additionally, an indicator (and/or an amount of discount or rebate associated with the offer) may be presented adjacent to a transaction on the user's transaction history which may be accessible via at least one of the user's financial institution account or social networking account. The visual aspects (e.g., color, font, type of picture, or the like) of the indicator based on clearance information may be different from the visual aspects of the indicator based on the authorization information. In some embodiments, a second indicator based on clearance information is presented adjacent to and in addition to a first indicator based on authorization information. In other embodiments, the second indicator based on clearance information replaces the first indicator based on authorization information after clearance of the transaction. In some embodiments, the indicator (and/or an amount of discount or rebate associated with the offer) may be presented in a pop-up window when the user selects (e.g., clicks, hovers over, or the like) a transaction from the transaction history. In some embodiments, a transaction that qualifies for an activated offer (determined based on clearance information associated with the transaction) may be presented differently (e.g., different color, background, font, projection or the like) from a transaction that qualifies for an offer (determined based on authorization information associated with the transaction) or from a transaction that does not qualify for an activated offer. In some embodiments, an indicator, as described herein, may comprise an amount of discount or rebate associated with the offer.

If the system had previously sent the user a message indicating that the user's transaction qualifies for the offer (and that the user will receive a rebate or discount associated with the offer), and if the system now determines, based on the clearance information, that the transaction no longer for the activated offer, the user receives (from the system) a text message, email message, social network message, financial institution network message, or the like, indicating the transaction no longer qualifies for the offer. Additionally, the message may indicate the reason why the transaction no longer qualifies for the offer (e.g., the user returned the purchase). Additionally if an indicator was displayed adjacent to a transaction indicating the transaction qualifies for an activated offer (based on authorization information associated with a transaction), the indicator is removed after the system determines the transaction no longer qualifies for an activated offer (based on clearance information associated with the transaction). Additionally, if the visual appearance (e.g., color, background, font, projection or the like) of a transaction that qualified for an activated offer was changed (based on authorization information associated with the transaction), the visual appearance of the transaction is returned to its original form such that the transaction looks visually similar to other transactions in the transaction history that are not associated with (or do not qualify for) any activated offers. In some embodiments, the system determines that the transaction no longer qualifies for the offer if the system determines that a previously authorized transaction that qualified for the offer has not settled a predetermined period (e.g. seven days) after authorization of the transaction.

In some embodiments, upon authorization of the payment, the system determines that the transaction does not qualify for an activated offer (e.g., because the amount of the transaction is $45 while the transaction would have qualified for the offer if the amount of the transaction was at least greater than $50). Therefore, the system does not send a message to the user and/or does not present an indicator adjacent to the transaction on the transaction history associated with the user's account. However, upon clearance of the transaction, the system determines that the amount of the transaction is $55 (the user added a $10 tip on the receipt), and therefore the transaction qualifies for the offer. Therefore, as described herein, upon (e.g., immediately upon) clearance of the transaction, the system sends a message to the user indicating the user will receive (or has received) a discount or rebate associated with the transaction. The message might also indicate the amount of the discount or rebate. In some embodiments, as described herein, the system may additionally initiate presentation of an indicator adjacent to the transaction in the transaction history, wherein the indicator indicates the user will receive a discount or rebate associated with the transaction. In some embodiments, the indicator (and/or an amount of discount or rebate associated with the offer) may be presented in a pop-up window when the user selects (e.g., clicks, hovers over, or the like) a transaction from the transaction history. In some embodiments, a transaction that qualifies for an activated offer (determined based on clearance information associated with the transaction) may be presented differently (e.g., different color, background, font, projection or the like) from a transaction that qualifies for an offer (determined based on authorization information associated with the transaction) or from a transaction that does not qualify for an activated offer. In some embodiments, an indicator, as described herein, may additionally comprise an amount of discount or rebate associated with the offer.

As an example, a user may activate an offer associated with a restaurant and may subsequently execute a purchase transaction at the restaurant prior to the expiration date of the offer. Immediately after the transaction is performed, a system described herein receives information associated with the offer (e.g., rules associated with executing a transaction that qualifies for the offer), information associated with the user's activation of the offer, and authorization information associated with the transaction. If the user made a qualifying transaction based on rules associated with the offer and based on the authorization information associated with the transaction, a message is transmitted to the user indicating the user may receive a rebate at a predetermined period in the future. At settlement, the system determines whether the transaction still qualifies for the offer (e.g., whether the transaction amount is still greater than or equal to a minimum transaction amount associated with the offer). At settlement if the system determines that the transaction still qualifies for the offer, the system transmits a message to the user indicating the user will receive a rebate within a predetermined number of days. At settlement, if the system determines that the transaction no longer qualifies for the offer, the system transmits a message to the user indicating the user will not receive a rebate because the transaction did not qualify for the offer. As previously described, transaction information associated with authorization of a transaction may be different from transaction information associated with settlement of the transaction.

Additionally, visual indicators associated with offers and/or transaction are presented on the user's account based on a status associated with the offer and/or the transaction. The offer may be presented separately in a list of offers or in-line with a list of transactions. For example, a first visual indicator may be presented adjacent to a new offer (e.g., an offer that has not been previously presented to the user or has been presented to the user for less than or equal to a predetermined period of time), a second visual indicator is presented adjacent to an activated offer, a third visual indicator is presented adjacent to an offer for which a qualifying transaction was made (or adjacent to the qualifying transaction in the transaction history), wherein the qualification of the transaction was based on authorization information associated with the transaction immediately after execution of the transaction, a fourth visual indicator is presented adjacent to an offer for which a qualifying transaction was made (or adjacent to the qualifying transaction in the transaction history), wherein the qualification of the transaction was based on settlement information associated with the transaction, or a fifth visual indicator is presented adjacent to an offer for which a non-qualifying transaction was made (or adjacent to the non-qualifying transaction in the transaction history), wherein the non-qualification of the transaction was based on settlement information associated with the transaction. In some embodiments, rather than or in addition to presenting a visual indicator adjacent to an offer and/or a transaction, the visual appearance of the offer and/or the transaction may be altered based on a status associated with the offer and/or the transaction.

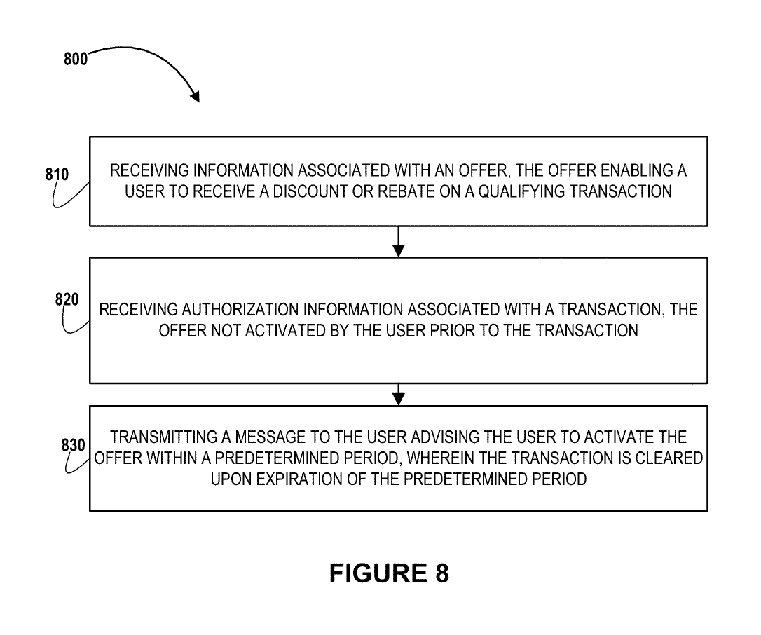

Referring now to FIG. 8, a general process flow 800 is provided for adaptively responding to a transaction executed by a user. At block 810, the method comprises receiving information associated with an offer, the offer enabling a user to receive a discount or rebate on a qualifying transaction. At block 820, the method comprises receiving authorization information associated with a transaction, the offer not activated by the user prior to the transaction. At block 830, the method comprises transmitting a message to the user advising the user to activate the offer within a predetermined period (e.g., a day), wherein the transaction is cleared upon expiration of the predetermined period. In some embodiments, the module is configured to transmit the message to the user after (e.g., immediately after) the module receives authorization information associated with the transaction. In other embodiments, the module is configured to transmit the message to the user at any point in time prior to the clearance of the transaction. Therefore, the invention enables providing immediate feedback to the user regarding a transaction executed by the user. Additionally, the invention enables the user to receive a discount or rebate associated with an offer after executing a transaction. As described herein, there is a time period between authorization of a transaction and clearance of the transaction. As used herein, the term “adaptive” refers to the system's real-time or near-time response to a user's transaction, wherein the type of response is adapted to the type of transaction executed by the user. As used herein, “immediately after” may refer to a few seconds, minutes, hours, or the like.

In some embodiments, the message comprises the offer or a link to the offer. Additionally, the message may comprise an option to activate the offer. Additionally, the message may also comprise an option to reject the offer. In some embodiments, the message is transmitted to the user via at least one of text or multimedia message, email message, social network message, financial institution network message. In some embodiments, the message indicates an amount of the discount or rebate associated with the transaction assuming the user activates the offer prior to clearance of the transaction. In some embodiments, if the user does not activate the offer upon receiving the message (and/or if the user does not select an option to reject the offer), the system may be configured to send periodic offer activation reminder messages (e.g., every few hours) to the user until the expiration of the predetermined period (e.g, when the transaction is cleared). In some embodiments, the message may indicate the amount of time remaining for the user to activate the offer (e.g., the amount of time until clearance of the transaction).

In some embodiments, the offer may have been transmitted to or presented to the user prior to the transaction, but the offer may not have been activated by the user or automatically activated based on one or more pre-configured user preferences prior to the transaction. In other embodiments, the offer may not have been transmitted to or presented to the user prior to the transaction.

In some embodiments, the transaction may be a transaction associated with a first merchant. The message may inform the user that the offer is associated with a second merchant. The second merchant may be a competitor of the first merchant such that the user can make the same purchase (or similar purchase) at the second merchant. The second merchant may be located close to the first merchant (e.g., in the same mall, zip code, city, or the like). Therefore, in some embodiments, the physical distance between the first merchant and the second merchant may not exceed a predetermined distance.

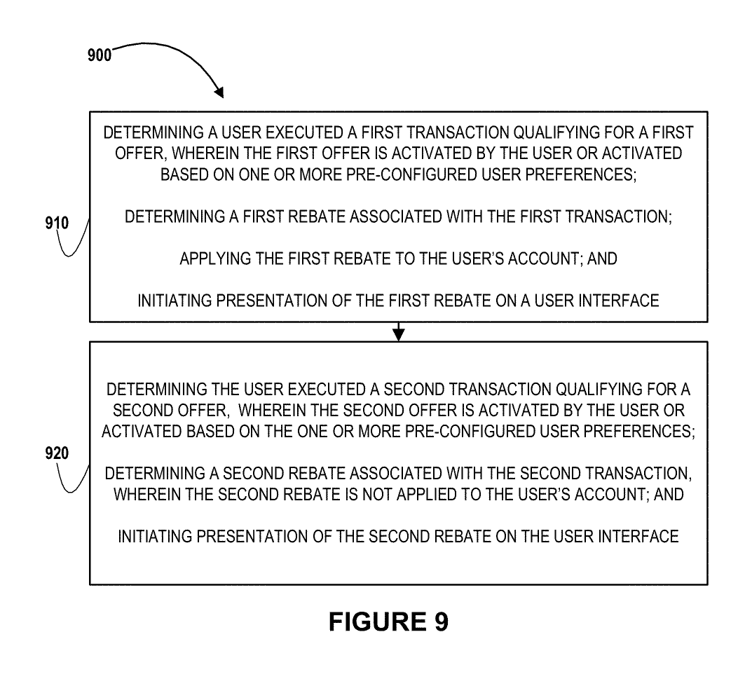

Referring now to FIG. 9, a general process flow 900 is provided for initiating presentation of a rebate on a user interface. At block 910, the process flow comprises determining a user executed a first transaction qualifying for a first offer, wherein the first offer is activated by the user or activated based on one or more pre-configured user preferences; determining a first rebate associated with the first transaction; applying the first rebate to the user's account; and initiating presentation of the first rebate on a user interface. At block 920, the process flow comprises determining the user executed a second transaction qualifying for a second offer, wherein the second offer is activated by the user or activated based on the one or more pre-configured user preferences; determining a second rebate associated with the second transaction, wherein the second rebate is not applied to the user's account; and initiating presentation of the second rebate on the user interface. Therefore, the present invention enables a user to view rebates that have already been applied to the user's account, and rebates that may or may not be applied to the user's account in the future (e.g., rebates that may possibly be applied to the user's account in the future). The rebate amounts presented on the user interface may be updated immediately (e.g., in real-time or in near real-time) or a predetermined period upon determining the user executed a transaction that qualifies for a rebate. As used herein, a rebate may also be referred to as a discount.

The first rebate is based on clearance information associated with the first transaction. Since the first rebate is based on clearance information, the first rebate is applied to the user's account upon clearance of the first transaction (or a predetermined period after clearance of the transaction). Since the first rebate amount is based on clearance information, the first rebate amount on the user interface is not updated immediately upon determining the user executed a transaction that qualifies for an offer; instead, the first rebate amount is updated upon clearance of the first transaction. The second rebate is based on authorization information associated with the second transaction. Since the second rebate amount is based on authorization information, the second rebate amount is updated immediately upon determining the user executed a transaction that qualifies for a rebate. Since the second rebate is based on authorization information (and not based on clearance information), the second rebate is not applied to the user's account upon authorization of the second transaction. The second rebate may or may not be applied to the account upon clearance of the second transaction. At a predetermined time following authorization of the second transaction, the second transaction is processed based on clearance information associated with the second transaction. If the second transaction qualifies for the rebate based on clearance information associated with the second transaction, the second rebate is applied to the account. If the second transaction does not qualify for the rebate based on clearance information associated with the second transaction, the second rebate is not applied to the account. As an example, the second transaction may qualify for the rebate if the transaction amount at clearance is greater than a predetermined amount specified by an offer. As a further example, the second transaction may qualify for the rebate if the user did not return the purchase associated with the second transaction prior to clearance of the second transaction.

The system may be configured to determine the user executed a transaction. Additionally, the system may be configured to determine an offer not activated by the user and not activated based on the one or more pre-configured user preferences, wherein the offer enables the user to receive a rebate on the transaction. Additionally, the system may be configured to determine a rebate associated with the transaction if the user had activated the offer either prior to or after the user executed the transaction. Since the user did not activate the offer, the rebate associated with the offer is not applied to the user's account. Additionally, the system may be configured to initiate presentation of the rebate (e.g., the missed rebate) on the user interface. Therefore, the present invention enables a user to view missed opportunities (e.g., missed rebates). Additionally, the system may be configured to initiate presentation of a message associated with the missed opportunity (e.g., “Did you know you could have saved $2 on this transaction if you had activated your offer?”).

Alternatively, the transaction may be executed at a first merchant. However, the offer enables the user to receive a rebate on a transaction executed at a second merchant, and not at the first merchant. The first and second merchants may be competitors such that the user may execute the same or similar transactions (associated with the same or similar goods or services) at both the first and second merchants. Therefore, the rebate presented on the user interface informs the user of the amount saved (e.g., the rebate) if the user had activated the offer (either prior to or after executing the transaction) and executed the same transaction (e.g., of the same good or service) or a similar transaction (e.g., of a similar or substitute good or service) at the second merchant, and not at the first merchant. Therefore, the system is configured to determine an amount saved by the user in executing the transaction at the second merchant versus executing the transaction at the first merchant, and is configured to initiate presentation of the potential amount saved (e.g., the missed rebate) on the user interface. Additionally, the system may be configured to initiate presentation of a message associated with the missed opportunity (e.g., “Did you know you could have saved $2 on this purchase if you had activated Merchant B's offer and shopped at Merchant B instead of Merchant A?”).

The system may be configured to determine the user executed a transaction at a first merchant. Additionally, the system may be configured to determine an offer activated by the user or activated based on one or more pre-configured user preferences, wherein the offer enables the user to receive a rebate on a transaction executed at a second merchant (and not at the first merchant). Additionally, the system may be configured to determine a rebate associated with the transaction if the user had executed the transaction at the second merchant, and not at the first merchant. Since the user did not execute the transaction at the second merchant, this rebate is not applied to the user's account. However, the system initiates presentation of the rebate (e.g., the missed rebate) on the user interface. Therefore, the rebate presented on the user interface informs the user of the amount saved if the user had executed the same transaction (e.g., of the same good or service) or a similar transaction (e.g., of a substitute or similar good or service) at the second merchant, and not at the first merchant. Additionally, the system may be configured to initiate presentation of a message associated with the missed opportunity (e.g., “You had previously activated an offer for Merchant B. Did you know you could have saved $2 on this purchase if you shopped at Merchant B instead of Merchant A?”). In some embodiments described herein, the first and second merchants are two different fuel stations (associated with the same or different fuel entities), departmental stores, or the like. Therefore, for example, the message may read: “Did you know you could have saved $2 on this fuel purchase if you purchased fuel at Fuel Station B instead of Fuel Station A?”.

The system may be configured to determine a rebate applied to an account of a second user (or accounts of multiple second users), and initiate presentation of a comparison of the rebates applied to the user's account (and/or rebates that may or may not be applied to the user's account in the future) with the rebates applied to the account of the second user (and/or rebates that may or may not be applied to the second user's account in the future). The second user may be at least one of a friend of the user, a family member of the user, a work colleague of the user, or a person who lives in the same neighborhood (e.g., zip code) as the user. Alternatively or additionally, the second user may be someone with similar demographic information, salary information, job profile information, work history information, residence history information, education information, or transaction history information as the user. In some embodiments, the second user lives in the same neighborhood as the user if the second user's residence address is less than a predetermined distance from the user's residence address. In some embodiments, the second user may be another user that has an account (e.g., a financial institution account, a social networking account, or the like). Therefore, the invention enables the user to compare the user's rebates to rebates associated with or applied to other users' accounts. Additionally, the user interface may present a message comparing the user's rebates and other users' rebates (e.g., “Other customers in your zip code have saved an average of $10 on clothing while you have not,” “Did you know you were in the bottom (or top) quartile of users who saved money on this program?,” or the like). The comparison may be presented via text or via statistical graphs or charts. Additionally, the user's rebate user interface may be visible to another user described herein if the user selects an option (e.g., an option associated with the user's account) to make the user's rebate user interface visible to another user (e.g., via a social network). In some embodiments, the user may select an option to make the user's rebate user interface either privately visible to a selected user or publicly visible to any user.

The user interface may be associated with at least one of the user's financial institution account, social networking account, or communication account (e.g., email, text or multimedia message, or the like). Additionally or alternatively, the user interface comprises a user interface associated with at least one of a mobile device (e.g., a portable mobile communication device) or a television. The user interface may be associated with any user channel (e.g., mobile channel) that is accessible to the user. In some embodiments, the user interface may be comprised in a widget (e.g., a marketing widget) or a dashboard, wherein the widget or dashboard may be presented on any user channel. For example, the widget (e.g., a flashing or static widget) may be presented in the corner of a television interface.

In some embodiments, the widget (or the user interface) may be comprised in readable indicia. A user may capture an image of or scan the readable indicia to view the user interface. In some embodiments, the readable indicia comprises visual indicia, e.g., a barcode, a Quick Response (QR) code, or the like. The readable indicia may comprise any one-dimensional or two-dimensional code. The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, or the like). A user may bring a mobile device in close proximity to the tag in order to receive information (e.g., readable indicia) associated with the tag.

In addition to or instead of presenting the rebates described previously, the system may be further configured to initiate presentation on the user interface of at least one of: an activated or inactivated currently available offer, a new offer, wherein the new offer was recently transmitted to the user, an offer that will expire in a predetermined period, or a featured offer, wherein a visual aspect of the featured offer differs from a visual aspect of a non-featured offer. A currently available offer may be an offer that has been presented on the user interface for at least a predetermined period of time (e.g., two weeks). A new offer may be an offer that has been presented on the user interface for less than a predetermined period of time (e.g., two days). As used herein, presenting an offer on a user interface comprises transmitting an offer to a user. A featured offer may be associated with a particular merchant (and/or associated with a particular product or service). The featured offer may be highlighted when compared to the other presented offers (e.g., the featured offer is presented in a different font, bigger text size, different colored background, or the like). Additionally, the featured offer may be positioned differently from the other presented offers (e.g., the featured offer may be presented at the top of a list of offers or may be presented separately from the list of offers or may be presented on its own interface page).

As described herein, in some embodiments, the transaction (e.g., first transaction, second transaction, or any other transaction described herein) qualifies for the offer based on the transaction being occurring during a predetermined period. Additionally, as described herein, in some embodiments, the transaction qualifies for the offer based on an amount associated with the transaction being greater than a predetermined amount. Additionally, as described herein, in some embodiments, the module is further configured to determine, when processing the transaction and/or the offer, whether the offer is active and whether the offer is valid. Additionally, as described herein, in some embodiments, the transaction qualifies for the offer based on a payment method associated with the transaction. Additionally, as described herein, the transaction may be executed by any user in a household of users.

As described herein, in some embodiments, the offer (e.g., first offer, second offer, or any other offer described herein) is transmitted to the user based on offer information associated with the offer substantially matching at least one of user information or account information associated with the user, wherein the account information comprises a transaction history associated with the user's financial institution account, and wherein the transaction history comprises at least one of a type of a transaction, a frequency associated with the transaction, an amount associated with the transaction, or a merchant associated with the transaction, and wherein the user information comprises personal information associated with at least one of the user, a family member of the user, or a friend of the user, wherein the personal information comprises at least one of demographic information, salary information, contact information, residence address information, job profile information, education information, or social network information.

As described herein, in some embodiments, the offer is transmitted to the user based on the user not being excluded by at least one user exclusion rule and the merchant not being excluded by at least one merchant exclusion rule, wherein the at least one user exclusion rule comprises at least one of an affinity exclusion rule, a risk exclusion rule, or an account exclusion rule, and wherein the at least one merchant exclusion rule comprises a merchant category code exclusion rule, and wherein the at least one merchant exclusion rule is based at least partially on a list of merchants associated with an excluded merchant category code that are not excluded.

As described herein, in some embodiments, the offer is presented to the user on a portable mobile communication device. As described herein, in some embodiments, the offer is presented via at least one of a user interface associated with the user's financial institution account, a user interface associated with the user's social network account, email, or text message. As described herein, in some embodiments, the offer comprises an offer to receive at least one of a discount or a rebate on at least one of: a purchase previously made by the user, a purchase from a merchant from which the user previously made a purchase, an alternative to the purchase previously made by the user, an alternative to the purchase from the merchant from which the user previously made a purchase, or a product or service related to a purchase previously made by the user. As described herein, in some embodiments, the transaction comprises an aggregate of a plurality of purchases or a largest purchase.

As described herein, in some embodiments, the processing or settlement of the transaction is executed as part of a batch processing operation, wherein the batch processing operation comprises processing a plurality of financial institution accounts, wherein a discount or rebate associated with the offer is applied to a financial institution account of the user during or at the completion of the batch processing operation. In some embodiments, the clearance of the transaction comprises the processing or settlement of the transaction as described herein. Therefore, in some embodiments, the clearance of the transaction (and/or the offer) may also be referred to as the processing or settling of the transaction (and/or the offer). In other embodiments, the processing or settlement of the transaction (and/or the offer) is executed a predetermined period after clearance of the transaction.

In some embodiments, there may be a predetermined period between the settlement of the transaction and/or the offer and the payment or posting of the rebate to the user's account. In some embodiments, the user interface displays rebates earned by the user that have been paid to the user's account and rebates earned by the user that have not yet been paid to the user's account. Additionally, the user interface displays rebates that may have been earned by the user (rebates that the system determines that the user may have earned based on near real-time match processing, e.g., based on authorization information associated with a transaction). At settlement, the system determines whether the rebates that may have been earned by the user are actually payable to the user. Therefore, if the system determines that the rebates that may have been earned by the user are actually payable to the user, the rebate is moved to the category of rebates earned by the user but not yet paid to the user. After a subsequent period when the rebate is posted to the user's account, the rebate is moved to the category of rebates earned by the user and paid to the user.

In some embodiments, the system described herein has geo-location capability. Therefore, the system may determine the location of a user based on location coordinates (e.g., global positioning system GPS) coordinates associated the user's mobile device. Subsequently, the system may transmit offers to the user's mobile device, wherein the offers are associated with merchants located within a predetermined distance of the mobile device.

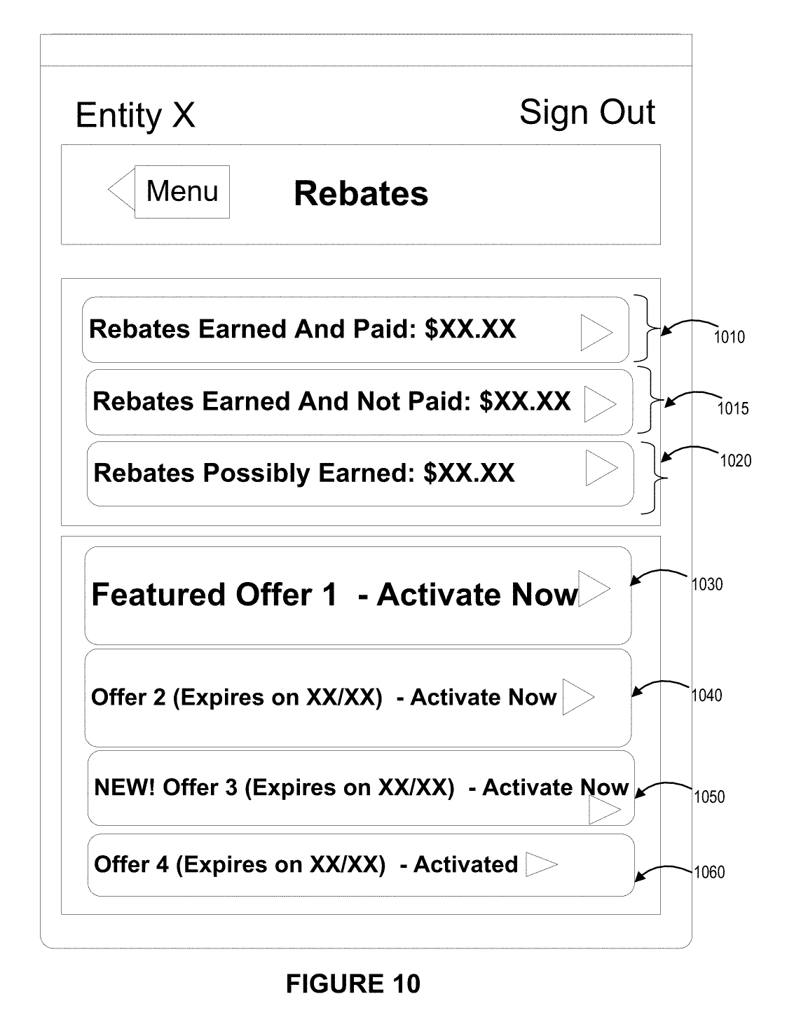

Referring now to FIG. 10, FIG. 10 is an exemplary user interface presenting rebates associated with user transactions, in accordance with embodiments of the present invention. FIG. 10 illustrates an account interface (e.g., financial institution account interface) presented on a mobile device. As indicated in FIG. 10, the user interface presents the rebates earned and paid 1010, the rebates earned and not paid 1015, and the rebates possibly earned by the user 1020 (or may have been earned by the user). Additionally, FIG. 10 illustrates a featured offer 1030. As indicated in FIG. 10, the featured offer 1030 is presented in a different (e.g., bigger) font size compared to the rest of the offers. Additionally, FIG. 10 illustrates a currently available offer 1040 along with an expiration date for the offer. Additionally, FIG. 10 illustrates a newly available offer 1050 along with an expiration date for the offer. For each of the above-described offers, the user interface includes an option to activate the offers. As used herein, an expiration date associated with the offer is the last date on which the user needs to activate the offer or the last date on which the user needs to execute a transaction associated with the offer that either follows or is preceded by activation of the offer. Additionally, FIG. 10 illustrates an offer 1060 that has been activated by the user or automatically activated based on one or more pre-configured user preferences along with an expiration date for the offer.

Targeted Resource Token Generation and Deployment

Various embodiments of the invention utilize some or all the process steps discussed above in order to implement a system for targeted resource token generation and deployment. In other embodiments of the invention, none of the process steps discussed above are utilized in such systems.

Namely, some embodiments enable targeted resource token generation and deployment. Embodiments generate gamification for awarding a customer for improving his or her financial wellness. Linking gamification to one or more rewards programs (such as the rewards program discussed in detail above) or other functionality previously unused by the customer, embodiments, reward customers by enrolling in previously unused programs. The system may identify customers to target that are not using the bank platforms desired. The system may provide the customer with opportunities to join the platform and, in return, the system generates and awards the customer with tokens (i.e., virtual coins or other rewards). Furthermore, each time a qualifying deal or banking platform is utilized a coin may be awarded to the customer. In other embodiments, trying something new or integrating into a new channel may award a coin. Thus, the system is encouraging a customer to enroll in or utilize various channels and platforms available to the customer that may be underutilized by the customer. These coins are stored and accumulated. The coins a customer collects may correspond to levels of opportunity. Each level generates a game or other interaction based on the level and may provide a cash award, charity donation, or the like upon completion of the game. The games are typically provided on a financial institution directed platform for games (i.e., on a mobile application or online banking session or widget) that actually provides a meaningful reward to the customer.

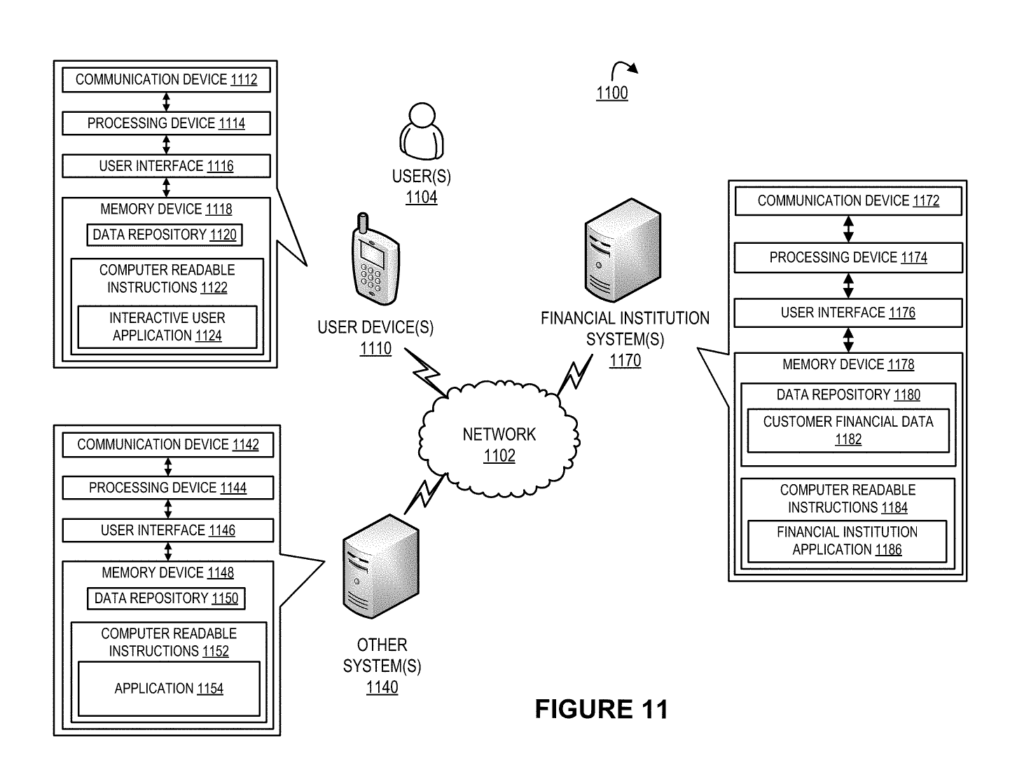

Referring to FIG. 11, the figure illustrates an electronic targeted resource token generation and deployment system environment 1100, in accordance with some embodiments of the invention. The environment 1100 includes a user device 1110 associated or used with authorization of a user 1104 (e.g., a mobile application user, and the like), one or more other system(s) 1140, and a financial institution system 1170.

As used herein, a “processing device,” such as the processing devices 1114, 1144, and 1174 generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer- eadable medium, and/or by having one or more application-specific circuits perform the function.

As used herein, a “user interface” such as the user interfaces 1116, 1146, and 1176 generally includes a plurality of interface devices and/or software that allow a customer to input commands and data to direct the processing device to execute instructions. For example, the user interfaces presented in FIG. 11 may include a graphical user interface (GUI) or an interface to input computer-executable instructions that direct the processing device to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” such as memory devices 1118, 1148, and 1178 generally refers to a device or combination of devices that store one or more forms of computer-readable media for storing data and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein.

As used herein, a “communication interface” generally includes a modem, server, transceiver, and/or other device for communicating with other devices on a network, and/or a user interface for communicating with one or more customers. Referring again to FIG. 11, the communication devices 1112, 1142, and 1172 are communication interfaces having one or more devices configured to communicate with one or more other devices on a network, such as a mobile device, a personal computing device, a mobile banking system, other financial institution banking systems, third party systems, and/or the like. The processing device is configured to use the network communication device to transmit and/or receive data and/or commands to and/or from the other devices connected to the network.

The systems and devices communicate with one another over the network 1102 and perform one or more of the various steps and/or methods according to embodiments of the disclosure discussed herein. The network 1102 may include a local area network (LAN), a wide area network (WAN), and/or a global area network (GAN). The network 1102 may provide for wireline, wireless, or a combination of wireline and wireless communication between devices in the network. In one embodiment, the network 1102 includes the Internet.

The user device 1110 includes a communication device 1112 communicably coupled with a processing device 1114, which is also communicably coupled with a memory device 1118. In some embodiments, the communication device 1112 may also comprise a GPS transceiver capable of determining a geographic location associated with the user device 1110. The processing device 1114 is configured to control the communication device 1112 such that the user device 1110 communicates across the network 1102 with one or more other systems. The processing device 1114 is also configured to access the memory device 1118 in order to read the computer readable instructions 1122, which in some embodiments includes an interactive user application 1124. The interactive user application 1124 allows for communication of the user device 1110 with the other systems and devices within the environment 1100 such as the other system(s) 1140, and financial institution system 1170. The user application 1124 allows the user 1104 to receive information transmitted as well as input information requested by the other systems and communicate with a financial institution, one or more third parties, and/or other entities. In some embodiments, the user application 1124 further allows the user to manipulate interactive tokens in order to generate an interaction program. The memory device 1118 also includes a data repository 1120 or database for storing pieces of data that can be accessed by the processing device 1114.

The other system(s) 1140 includes a communication device 1142 communicably coupled with a processing device 1144, which is also communicably coupled with a memory device 1148. The processing device 1144 is configured to control the communication device 1142 such that the other system(s) 1140 communicate across the network 1102 with one or more other systems. The processing device 1144 is also configured to access the memory device 1148 in order to read the computer readable instructions 1152, which in some embodiments includes an application 1154. The application 1154 allows for communication with the other systems and devices within the environment 1100 such as the user device 1110 and the financial institution system 1170. The memory device 1148 also includes a data repository 1150 or database for storing pieces of data that can be accessed by the processing device 1144. In some embodiments, the other system(s) 1140 may be part of the financial institution systems 1170 or the user device 1110.

As illustrated in FIG. 11, in one embodiment of the invention, the financial institution system 1170 includes a processing device 1174 operatively coupled to a network communication device 1172 and a memory device 1178. The financial institution system 1170 includes a communication device 1172 communicably coupled with a processing device 1174, which is also communicably coupled with a memory device 1178. The processing device 1174 is configured to control the communication device 1172 such that the financial institution system 1170 communicates across the network 1102 with one or more other systems. The processing device 1174 is also configured to access the memory device 1178 in order to read the computer readable instructions 1184, which in some embodiments includes a financial institution application 1186. The financial institution application 1186 allows for communication with the other systems and devices within the environment 1100 such as the user device 1110 and the interaction manipulation system 1140. The memory device 1178 also includes a data repository 1180 or database for storing pieces of data that can be accessed by the processing device 1174.

The user application 1124, the application 1154, and the financial institution application 1186 are for instructing the processing devices on their respective systems to perform various steps of the methods discussed herein, and/or other steps and/or similar steps. In various embodiments, one or more of the various applications discussed are included in the computer readable instructions stored in a memory device of one or more systems or devices other than their respective systems and/or devices. For example, in some embodiments, the application 1154 is stored and configured for being accessed by a processing device of the financial institution system 1170 connected to the network 1102. In various embodiments, the user application 1124, the application 1154, and the financial institution application 1186 are stored and executed by different systems/devices. In some embodiments, the discussed applications may be similar and may be configured to communicate with one another. In some embodiments, the various applications may be considered to be working together as a singular application despite being stored and executed on different systems.

In various embodiments, one of the systems discussed above, such as the financial institution system 1170, is more than one system and the various components of the system are not collocated, and in various embodiments, there are multiple components performing the functions indicated herein as a single device. For example, in one embodiment, multiple processing devices perform the functions of the processing device 1174 of the financial institution system 1170 described herein.

In various embodiments, the user device 1110, the interaction manipulation system 1140, the financial institution system 1170, and/or other systems may perform all or part of a one or more method or process steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

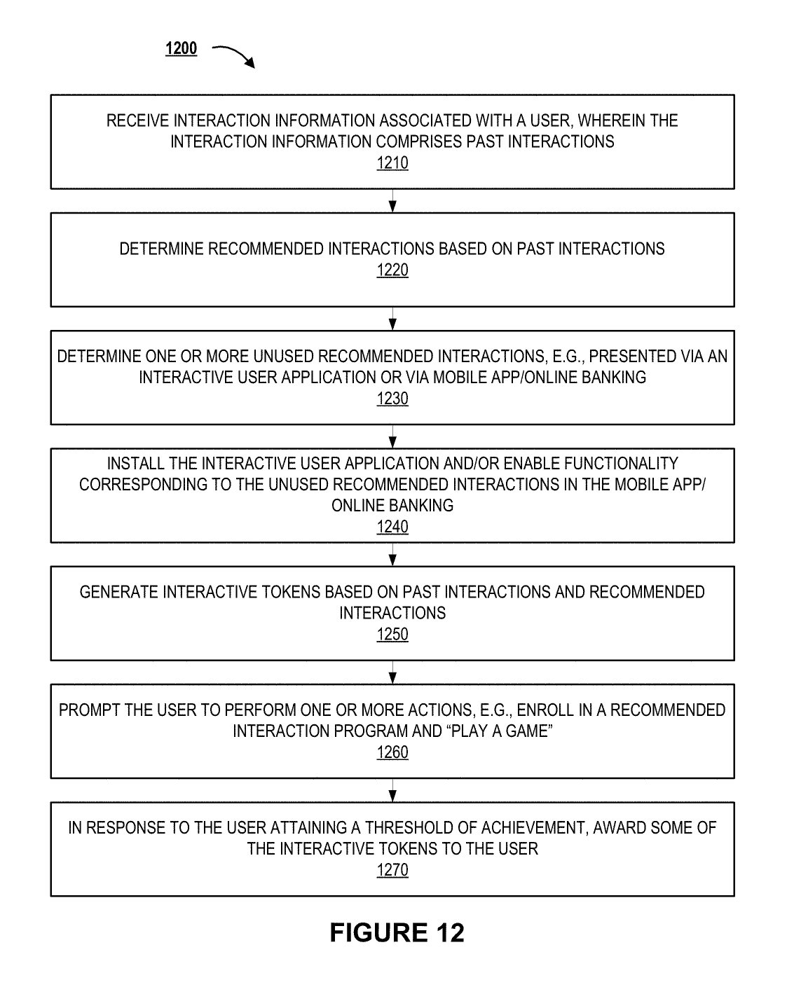

FIG. 12 illustrates a high level process flow for targeted resource token generation and deployment 1200, in accordance with one embodiment of the invention. As illustrated in block 1210, the process 1200 is initiated by first receiving interaction information associated with a user. Interaction information comprises financial or banking information associated with a user. In some embodiments, the system extracts interaction information associated with the user form one or more financial accounts such as a checking account, savings account, or the like. In some embodiments, the system and the interaction information associated with the user are maintained by the same entity, such as a financial institution or bank. In other embodiments, the system and interaction information associated with the user are maintained separately, by different entities or by one or more third parties. In some embodiments, the interaction information extracted by the system further comprises user-identifying, personal information, such as name, address, phone number, e-mail address, usernames, passwords, and other account information.

The interaction information may include a transactional history associated with a user, wherein the user's past interactions or transactions are included in the interaction information. Furthermore, interaction information may also include scheduled one-time and recurring payments such as automated bill payments, subscriptions, or the like.

In some embodiments, the interaction information may further comprise geolocation information associated with a user device associated with the user. The system may receive or extract geolocation information from a user device associated with the user. In some embodiments of the invention, the system may use the received geolocation information associated with the user device to further develop a profile of the user's transactional history and habits. For example, the system may extract from the geolocation information associated with the user device in combination with the user's past interactions that the user regularly makes purchases at a particular business, such as a particular grocery store or coffee shop. The system may further employ geolocation information to determine underutilized interactions or recurring transactions by determining that the user is not frequently located near a location, such as a business, associated with the underutilized interaction. For example, the system may determine that the user has a monthly gym membership from the user's transactional history, however the system also determines that the user has infrequently used the membership based on the user device associated with the user having not been located at the gym over the past month.

As illustrated in block 1220 of FIG. 12, the system determines one or more recommended interactions based on the past interactions. The one or more recommended interactions may be or include unused rewards programs or other functionality. In some embodiments the recommended interactions are new interactions that are not comparable to the user's past interactions. In some embodiments, a recommended interaction may have a lower cost than a comparable past transaction. By recommending to replace a past interaction with a new, recommended interaction, the system may assist the user in reducing financial costs to achieve a resource storage target. For example, based on identifying from past transactions that a user is paying a certain monthly amount for internet service from a first internet provider, the system may recommend that the user replace the interaction and instead receive internet service from a second internet provider who offers a comparable service for a lower monthly cost.

In some embodiments, the system further determines the one or more recommended interactions based on the geolocation information associated with the user device associated with the user. Determining that the user device associated with the user is located at a particular location, such as a particular store or business, may trigger the system to generate a recommended interaction associated with that particular store or business. For example, the system may use the geolocation information to determine that the user regularly shops at grocery store A and recommend that the user instead shop at grocery store B which is less expensive on average.

In some embodiments of the invention, the recommended interactions further comprise offers such as coupons, discounts, rebates, and the like which can supplement an interaction program associated with a user in order to reduce financial costs. The system may determine particular products or services regularly purchased by the user from the past interaction associated with the user. In some embodiments, the system prompts the user to categorize past interactions and provide additional details associated with specific purchases such as item level product or service identification, SKUs, barcodes, receipt information, or the like. For example, the system may determine that the user has purchased or regularly purchases a product and provide the user with a coupon for the product to reduce the user's expenditures.

In some embodiments, the system accesses a database of recommended interactions stored within the memory of the system to extract recommended interactions to the user. In some embodiments, the system may recommend interactions associated with businesses or entities affiliated with an entity maintaining the system. For example, a bank maintaining the invention may recommend interactions associated with businesses, partners, clients, or the like affiliated with the bank. In some embodiments, the system may provide recommended interactions associated with outside or third party entities. The system may establish operative communication channels to third party systems in order to extract information related to recommended interactions from the third party systems. In some embodiments, the system generates a repository of recommended interactions extracted from one or more third parties and other entities and stores them within the memory of the system. In this way, the system may provide the user with a single, comprehensive source of recommended interactions so that the user does not have to access additional systems to receive a holistic view of all available interactions. Additionally, in some embodiments, the system presents the user with the determined recommended interactions which reduces the amount of unnecessary information and data transmitted from the system to the user device. In this way, the system effectively filters potential interactions and presents a customized set of recommended interactions to the user.

As illustrated in block 1230 of FIG. 12, the system determines one or more unused recommended interactions. Once determined, the system may present the available unused recommended interactions over an interactive user application and/or using a mobile application on a mobile device or using an online banking session or widget.

As illustrated in block 1240 of FIG. 12, the system installs the interactive user application on a user device and/or enables functionality corresponding to the unused recommended interactions in the mobile application or online banking session. In some embodiments, the interactive user application is a part of an online banking application or mobile banking application installed on a user device. In some embodiments, installing the application comprises the user device accessing a website, digital store, or other system, wherein the application information is transmitted, installed, and stored within the memory of the user device. In some embodiments, the system transmits the application to the user device for installation.

As illustrated in block 1250 of FIG. 12, the system generates one or more interactive tokens based on past interactions and the recommended interactions. Interactive tokens generated by the system may be text, images, shapes, computer-generated objects, and the like presented to the user via the interactive user application that represent the one or more past and recommended interactions and may be manipulated by the user and/or system to assist in creating a revised interaction program. In some embodiments, the interactive tokens are generated or engineered to contain information or data related to the interaction associated with the token, such as pricing information, routing information associated with the provider of the interaction, product or service information associated with the interaction, and the like.

In some embodiments, the system may be triggered to generate one or more interactive tokens based the geolocation information associated with the user device. For example, the system may determine from the user's past interactions that the user normally shops at a more expensive grocery store A. Upon the determining from the received geolocation information that the user is located at a less expensive grocery store B, the system triggers the generation of an interactive token for a recommended interaction associated with shopping at the less expensive store.

As illustrated in block 1260 of FIG. 12, the system prompts the user to perform one or more actions. These actions may include or be enrolling in a particular program and/or playing a game or performing another interaction with an application or session.

In some embodiments of the invention, the interactive user application interacts with the user by a game, puzzle, or the like, wherein the user is prompted to manipulate the interactive tokens and/or perform other gaming actions by way of the user device.

In some embodiments, the system calculates a number potential recommended interactions and recommended interaction values necessary for achieving different levels within the rewards program, and in some cases achieving additional tokens and/or rewards such as cash rewards. In some embodiments, the system presents the user with multiple initial recommended interactions, wherein upon the user selecting one or more of the recommended interactions for inclusion in the interaction program, the system calculates a second number of potential recommended interactions and recommended interaction values necessary for achieving particular levels based on the initial selection by the user. In this way, the system may provide accurate choices to reflect the branching possibilities stemming from the user's selection from multiple initial options as each of the recommended interactions may possess varying values and contributions to a total interaction amount.

The examples discussed above should not be considered limiting as manipulation of or interaction with the interactive tokens and the interactive user application may comprise any manipulation of the interactive tokens and interactive user application by the user or the system which allows for the selection of one or more past and/or recommended interactions and the comparison of a total value of selected interactions to a one or more level thresholds for generating a revised interaction program which may include one or more additional games, opportunity and/or rewards such as cash rewards for the customer.

As illustrated in block 1270 of FIG. 12, the system, in response to the user attaining a threshold of achievement, awards some of the interactive tokens to the user.

In some embodiments, the system automatically enrolling the user in a recommended interaction, wherein the recommended interaction comprises a subscription, membership, service, utility payment, or other recurring payment. In some embodiments, enrolling the user in the recommended interaction further comprises automatically cancelling a past interaction associated with the user, wherein the past interaction is replaced by the recommended interaction. In some embodiments, the system uses interaction information associated with the user to enroll the user in the new recommended interaction.

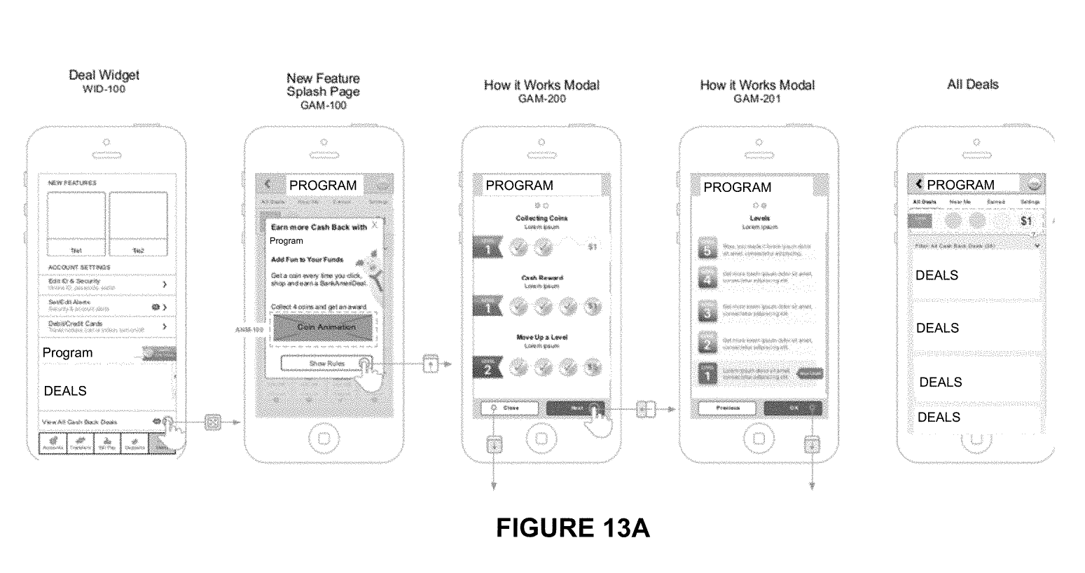

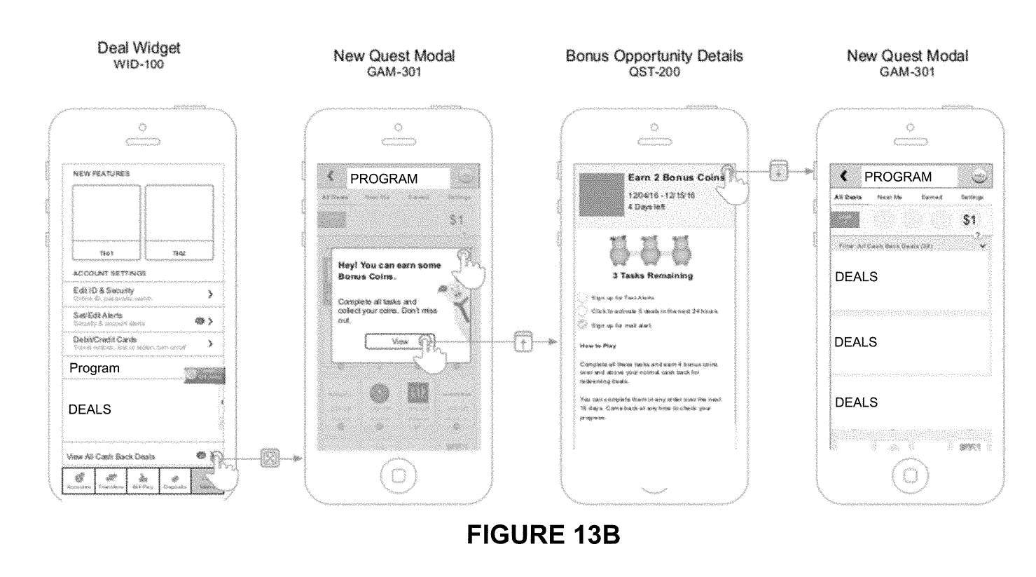

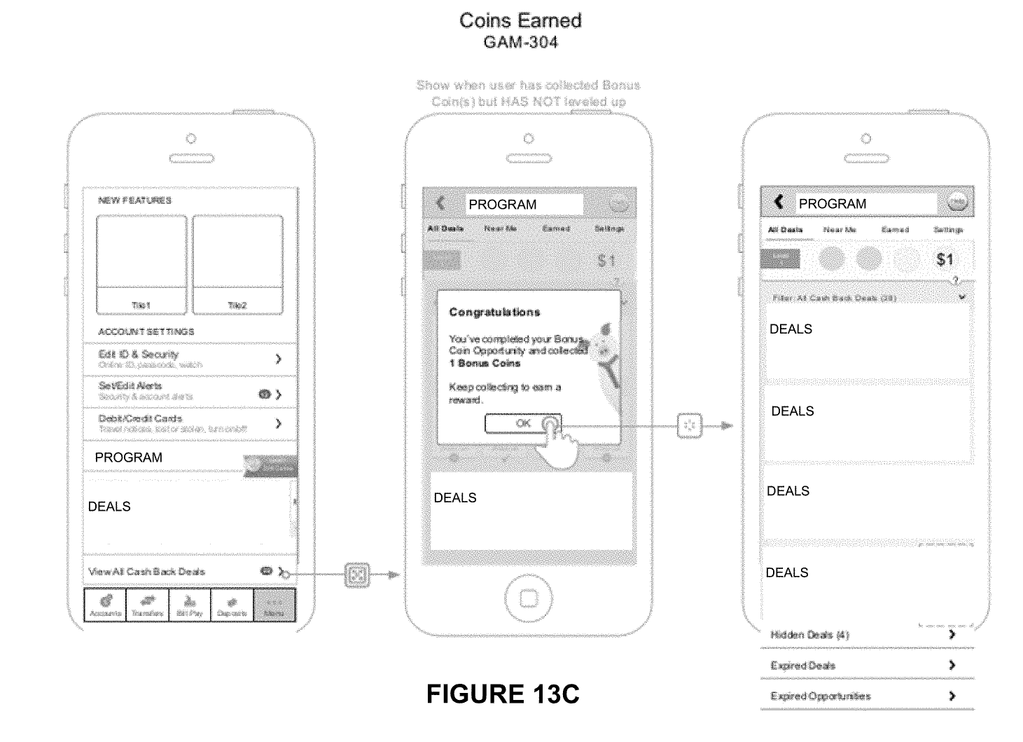

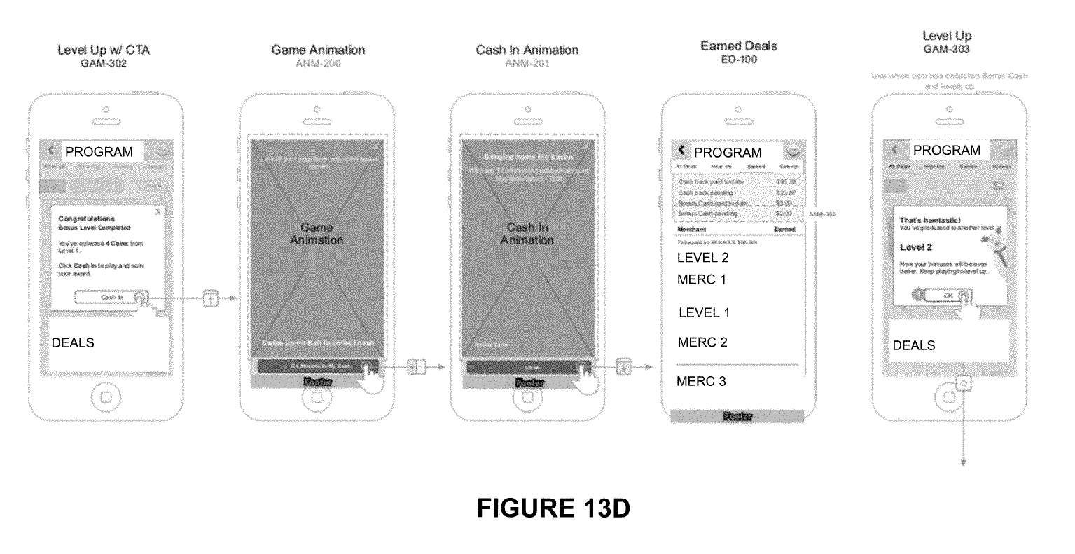

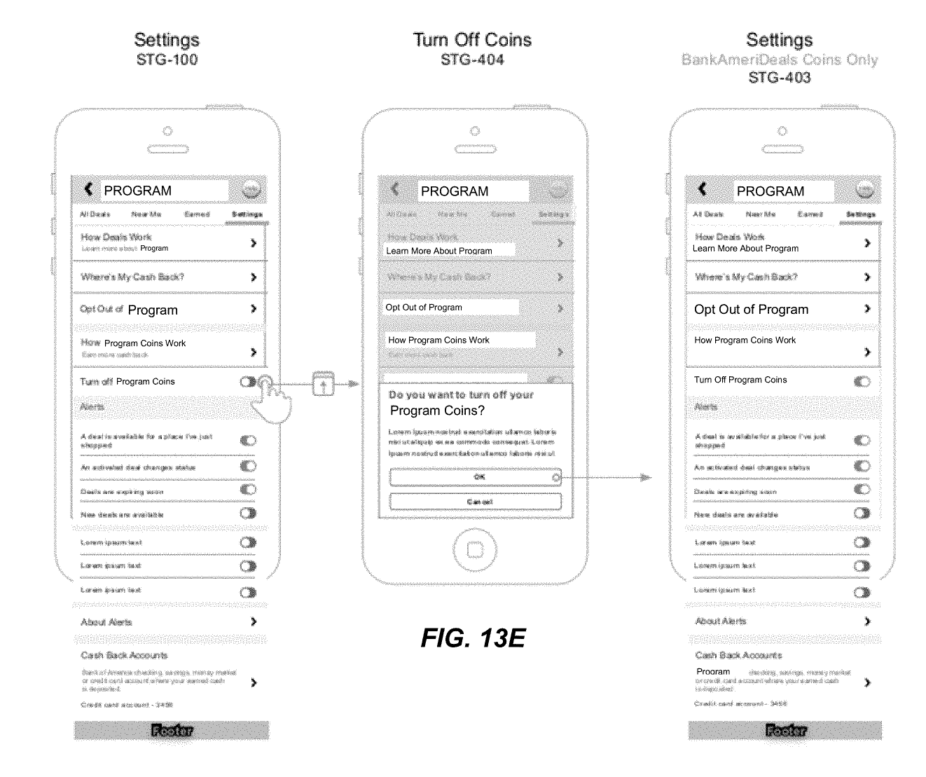

Referring now to FIGS. 13A-13E, screenshots of exemplary mobile device interfaces according to embodiments of the invention are illustrated. Figure. 13A illustrates a “splash feature” for the mobile device, wherein the mobile application presents the user with an opportunity to earn additional cash back by gathering tokens presented for enrolling or using specified deals or programs. FIG. 13B illustrates the mobile application presenting the user with an opportunity to earn bonus tokens by completing tasks. FIG. 13C illustrates the mobile application presenting the user with an opportunity for a bonus token collection, but where the user has not yet achieved sufficient tokens for leveling up for earning a reward (e.g., cash back). FIG. 13D illustrates the mobile application presenting the user with an opportunity for bonus resulting in leveling up and thereby earning a reward. FIG. 13E illustrates the mobile application presenting the user with the ability to turn off particular deals, rewards or token deployment.

In some embodiments, the system may establish an operative communication channel with a third party system to enroll and/or cancel user interactions with the third party. For example, in response to the user manipulating the interactive tokens to replace his/her internet service provider A with a less expensive internet service provider B, the system may use the extracted interaction information associated with the user to automatically create an account associated with the user and initiate payment from the user's account to the new internet service provider B. The system may further automatically cancel the past interaction with internet service provider A by transmitting a cancellation request via an operative communication channel or by stopping payment from the user's financial account.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein. In some embodiments, data such as transaction data, data related to the number or amount of tokens achieved or the level achieved by the user may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 7629US1.014033.2953 | To be assigned | THIRD PARTY ACTIVITY | Concurrently |
| | | PERFORMANCE CROSS ENTITY | herewith |
| | | INTEGRATION | |
| 7630US1.014033.2954 | To be assigned | SYSTEM AND METHOD FOR | Concurrently |
| | | LOCATION-BASED | herewith |
| | | TRAFFICKING FOR RESOURCE | |
| | | ACCUMULATION | |
| 7631US1.014033.2955 | To be assigned | CUSTOMIZED INTERACTION | Concurrently |
| | | MANIPULATION AND | herewith |
| | | IMPLEMENTATION FOR | |
| | | RESOURCE STORAGE | |
| 7632US1.014033.2956 | To be assigned | RESOURCE ALLOCATION | Concurrently |
| | | INTERFACE FOR INTERACTIVE | herewith |
| | | RESOURCE DISTRIBUTION | |

What is claimed is:

1. A system for targeted resource token generation and deployment, the system comprising:
at least one memory device with computer-readable program code stored thereon;
at least one communication device connected to a network;
at least one processing device operatively coupled to the at least one memory device and the at least one communication device, wherein the processing device is configured to execute the computer-readable program code to:
receive interaction information associated with a user, wherein the interaction information comprises past interactions;
in response to receiving the past interactions, determine recommended interactions based on the past interactions;
determine one or more unused recommended interactions;
present the unused recommended interactions to the user for consideration;
generate interactive tokens based on the past interactions and the recommended interactions;
prompt the user to perform one or more actions related to the unused recommended interactions;
determine that the user has attained at least a threshold level of achievement; and
in response, award some of the interactive tokens to the user.

2. The system of claim 1, wherein the processing device is further configured to execute the computer-readable program code to modify future user interactions including enrolling the user in at least one recommended interaction.

3. The system of claim 2, wherein the processing device is further configured to execute the computer-readable program code to:
generate and present a request for a confirmation the user wishes to enroll in the at least one recommended interaction;
receive the confirmation of the user's desire to enroll in the at least one recommended interaction from the user; and
based on receiving the confirmation, implement the enrollment.

4. The system of claim 1, wherein the processing device is further configured to execute the computer-readable program code to:
receive a user's instruction to redeem one or more deals; and
in response, award some of the interactive tokens to the user.

5. The system of claim 1, wherein the processing device is further configured to execute the computer-readable program code to:
present one or more programs to the user;
receive the user's input regarding the one or more programs; and
enable functionality corresponding to the unused recommended interactions for the user.

6. The system of claim 1, wherein performing the one or more actions comprises:
enrolling in one or more programs available to the user.

7. The system of claim 6, wherein the processing device is further configured to execute the computer-readable program code to:
determine a number of tokens awarded to the user exceeds a predetermined threshold; and
in response, determine that the user has unlocked an interactive game.

8. A computer program product for targeted resource token generation and deployment, the computer program product comprising at least one non-transitory computer readable medium having computer-readable program code portions embodied therein, the computer-readable program code portions comprising:
an executable portion configured for receiving interaction information associated with a user, wherein the interaction information comprises past interactions;
an executable portion configured for, in response to receiving the past interactions, determine recommended interactions based on the past interactions;
an executable portion configured for determining one or more unused recommended interactions;
an executable portion configured for presenting the unused recommended interactions to the user for consideration;
an executable portion configured for generating interactive tokens based on the past interactions and the recommended interactions;
an executable portion configured for prompting the user to perform one or more actions related to the unused recommended interactions;
an executable portion configured for determining that the user has attained at least a threshold level of achievement; and
an executable portion configured for, in response, awarding some of the interactive tokens to the user.

9. The computer program product of claim 8, wherein the computer-readable program code portions further comprise:
an executable portion configured for modifying future user interactions including enrolling the user in at least one recommended interaction.

10. The computer program product of claim 9, wherein the computer-readable program code portions further comprise:
an executable portion configured for generating and present a request for a confirmation the user wishes to enroll in the at least one recommended interaction;
an executable portion configured for receiving the confirmation of the user's desire to enroll in the at least one recommended interaction from the user; and
an executable portion configured for, based on receiving the confirmation, implementing the enrollment.

11. The computer program product of claim 8, wherein the computer-readable program code portions further comprise:
an executable portion configured for receiving a user's instruction to redeem one or more deals; and
an executable portion configured for, in response, awarding some of the interactive tokens to the user.

12. The computer program product of claim 8, wherein the computer-readable program code portions further comprise:
an executable portion configured for presenting one or more programs to the user;
an executable portion configured for receiving the user's input regarding the one or more programs; and
an executable portion configured for enabling functionality corresponding to the unused recommended interactions for the user.

13. The computer program product of claim 8, wherein the computer-readable program code portions further comprise:
an executable portion configured for enrolling in one or more programs available to the user.

14. The computer program product of claim 9, wherein the computer-readable program code portions further comprise:
an executable portion configured for determining a number of tokens awarded to the user exceeds a predetermined threshold; and
an executable portion configured for, in response, determine that the user has unlocked an interactive game.

15. A computer-implemented method for targeted resource token generation and deployment, the method comprising:
receiving interaction information associated with a user, wherein the interaction information comprises past interactions;
in response to receiving the past interactions, determining recommended interactions based on the past interactions;
determining one or more unused recommended interactions;
presenting the unused recommended interactions to the user for consideration;
generating interactive tokens based on the past interactions and the recommended interactions;
prompting the user to perform one or more actions related to the unused recommended interactions;
determining that the user has attained at least a threshold level of achievement; and
in response, awarding some of the interactive tokens to the user.

16. The method of claim 15, further comprising:
modifying future user interactions including enrolling the user in at least one recommended interaction.

17. The method of claim 16, further comprising:
generating and present a request for a confirmation the user wishes to enroll in the at least one recommended interaction;
receiving the confirmation of the user's desire to enroll in the at least one recommended interaction from the user; and
based on receiving the confirmation, implementing the enrollment.

18. The method of claim 15, further comprising:
receiving a user's instruction to redeem one or more deals; and
in response, awarding some of the interactive tokens to the user.

19. The method of claim 15, further comprising:
presenting one or more programs to the user;
receiving the user's input regarding the one or more programs; and
enabling functionality corresponding to the unused recommended interactions for the user.

20. The method of claim 15, wherein performing the one or more actions comprises:
enrolling in one or more programs available to the user.
